(19) United States
(12) Patent Application Publication
(10) Pub. No.: US 2008/0136958 A1
(43) Pub. Date: Jun. 12, 2008

(54) CAMERA HAVING A FOCUS ADJUSTING SYSTEM AND A FACE RECOGNITION FUNCTION

(75) Inventor: Naoto NAKAHARA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/953,311

(22) Filed: Dec. 10, 2007

(30) Foreign Application Priority Data
Dec. 11, 2006 (JP) 2006-333721
Jun. 1, 2007 (JP) 2007-146558

(51) Int. Cl. H04N 5/232

(52) U.S. Cl. 348/345; 348/E05.042

(57) ABSTRACT

A camera includes an image pickup device; a focus adjusting device which captures an object image at different positions while the focusing lens group is moved to detect an in-focus lens position, based on image signals of the object images, and the focusing lens group is moved to this in-focus lens position; and a face recognition device for recognizing a face image based on the image signals. When the face recognition device recognizes the face image, the focus adjusting device performs the focus search process toward the near extremity if the area size of the face image is smaller than a predetermined threshold value, and the focusing lens group moves toward the far extremity if the area size of the face image is equal to or greater than the predetermined threshold value.

### BACKGROUND OF THE INVENTION

1. Field of the Invention

The present invention relates to a focus adjusting system, and in particular relates to a camera having a contrast-detection focus adjusting system and a face recognition system.

2. Description of the Prior Art

Digital cameras with a contrast-detection focus adjusting system (focusing system) which detects a focus state (in-focus position) by performing a focus search operation are known in the art. In the focus search operation, images are captured consecutively at different positions of a focusing lens group while the focusing lens group is being moved stepwise from a search start extremity, which is one of the infinite focus position (far extremity/position for bringing an object at infinity into focus) and the closest (shortest) focus position (near extremity/position for bringing an object at the shortest distance in working range into focus), to a search end extremity (the other of the infinite focus position and the closest focus position) after having been moved to the search start extremity to detect a focus state based on contrasts of the captured images. Among such digital cameras, a type of digital camera having a face recognition function is known in the art. This function recognizes one or more faces (human faces) from the aforementioned captured images, detects contrasts of the faces and brings all the faces into focus (into a depth of focus). This type of digital camera is disclosed in Japanese unexamined patent publication No. 2006-208443.

In such a conventional digital camera, the aforementioned focus search operation commences upon the release button of the camera being depressed half way. Additionally, a camera in which the aforementioned search start extremity of the focusing lens group is determined in accordance with the stop position at the commencement of the aforementioned focus search operation and subsequently the focus search operation commences upon the focusing lens group being moved to the search start extremity, is known in the art. In addition, a camera in which the aforementioned focus search operation commences from a fixed (predetermined) search start extremity irrespective of the stop position of the focusing lens group at the commencement of the focus search operation is also known in the art.

However, if the focusing lens group starts moving from the near extremity to bring an object at infinity into focus or from the far extremity to bring an object at the shortest distance into focus in the focus search operation, a long period of time is required for the focus search operation, so that it takes time to bring an object into focus.

Additionally, in conventional cameras having a face recognition function, when recognizing faces, the face recognition function brings one of the face images which is the greatest in area size or the closest to the camera, and accordingly, a face image at a far distance may not be brought into focus if more than one face image exits in a picture area. Therefore, the time required to achieve an in-focus state becomes long if one tries to take a picture while achieving an in-focus state for each face image.

### SUMMARY OF THE INVENTION

The present invention provides a camera having a face recognition function and a contrast-detection focus adjusting system, wherein the time required for the focus search operation when the face recognition function is activated can be reduced.

Additionally, the present invention provides a camera having a face recognition function, wherein, when the face recognition function recognizes two or more faces located at different object distances, focal points on the recognized faces can be detected and all the recognized faces can be brought into focus in a short period of time.

According to an aspect of the present invention, a camera having a focus adjusting system and a face recognition function is provided, including an image pickup device for capturing an object image formed via a photographing optical system including a focusing lens group movable along an optical axis; a focus adjusting device which performs a focus search process, wherein the image pickup device is activated to capture an object image at each of a plurality of different positions of the focusing lens group in the optical axis direction while the focusing lens group is moved along the optical axis to detect an in-focus lens position of the focusing lens group in the optical axis direction, based on image signals of the object images obtained at the plurality of different positions of the focusing lens group, and wherein the focusing lens group is moved to the in-focus lens position detected by the focus search process; and a face recognition device for recognizing a face image based on the image signals. When the face recognition device recognizes the face image, the focus adjusting device performs the focus search process so that the focusing lens group moves toward the near extremity in the case where the area size of the face image is smaller than a predetermined threshold value, and so that the focusing lens group moves toward the far extremity in the case where the area size of the face image is one of equal to and greater than the predetermined threshold value.

As described above, according to an aspect of the present invention, when the face recognition device recognizes a face image in a captured image, the focus search process is performed so that the focusing lens group moves from the near extremity toward the far extremity if the area size of the face image is equal to or greater than a predetermined threshold value (i.e., if an object to be photographed is positioned on a short-distance side before a location a predetermined distance away), and so that the focusing lens group moves from the far extremity toward the near extremity if the area size of the face image is smaller than the predetermined threshold value (i.e., if an object to be photographed is positioned on a far-distance side behind the location the predetermined distance away), and therefore, an object to be photographed can be brought into focus in a shorter period of time if the object includes an face image.

When the face recognition device recognizes the face image, it is desirable for the focus adjusting device to detect the in-focus lens position of the focusing lens group as a position at which an in-focus state is achieved on the face image recognized by the face recognition device.

When the face recognition device recognizes the face image, it is desirable for the focus adjusting device to set an image area which includes the face image to serve as a focus detection area, and detects the in-focus lens position of the focusing lens group based on an image signal of the face image formed in the focus detection area.

It is desirable for the size of the focus detection area to remain unchanged regardless of the size of the image area.

It is desirable for the focus adjusting device to detect the in-focus lens position of the focusing lens group as a position thereof in the optical axis direction at which a peak contrast value in the image signal of the face image formed in the focus detection area is obtained.

Upon the peak contrast value being obtained during the focus search process, it is desirable for the focus adjusting device to terminate the focus search process and move the focusing lens group to the position at which the peak contrast value is obtained.

It is desirable for the photographing optical system to be a zoom lens, and for the predetermined threshold value to be determined based on a currently-set focal length of the zoom lens.

It is desirable for the camera to include a monitor which displays the object image captured by the image pickup device, wherein, when the face recognition device recognizes the face image while the focus adjusting device performs the focus search process, an image signal of an object image which is formed in an image area including the face image is extracted from among the image signals of the object images captured at the plurality of different positions of the focusing lens group to indicate a zoom-in image of the face image on the monitor.

It is desirable for the object image captured by the image pickup device to be displayed on the monitor after the focusing lens group is moved to the in-focus lens position following termination of the focus search process.

Upon focus being achieved on the image area including the face image, it is desirable for an identification indication which visually identifies the image area including the face image to be indicated on the monitor.

It is desirable for the identification indication to be a highlighted frame which surrounds the face image.

It is desirable for the camera having a contrast-detection focus adjusting system to include a monitor which displays the object image captured by the image pickup device. When the face recognition device recognizes the face image while the focus adjusting device performs the focus search process, the manner of indication of the monitor is switched to a zoom-in indication manner in which an image of the image signal obtained from an area of the recognized face image is zoomed in to be indicated on the monitor as a zoom-in image, while the focus adjusting device performs the focus search process.

It is desirable for the manner of indication of the monitor to be switched back to the aforementioned normal manner upon completion of the focusing drive process, when the focus search process is terminated.

In an embodiment, a camera having a focus adjusting system and a face recognition function is provide, including an image pickup device for capturing an object image formed via a photographing optical system including a focusing lens group movable along an optical axis; a focus adjusting device which performs a focus search process, wherein the image pickup device is activated to capture an object image at each of a plurality of different positions of the focusing lens group in the optical axis direction while the focusing lens group is moved along the optical axis between a near extremity thereof and a far extremity thereof to detect an in-focus lens position of the focusing lens group in the optical axis direction, based on image signals of the object images obtained at the plurality of different positions of the focusing lens group, and wherein the focusing lens group is moved to the in-focus lens position detected by the focus search process; and a face recognition device for recognizing a face image based on the image signals. When the face recognition device recognizes the face image, the focus adjusting device performs the focus search process so that the focusing lens group moves from the far extremity toward the near extremity in the case where the area size of the face image is smaller than a predetermined threshold value, and so that the focusing lens group moves from the near extremity toward the far extremity in the case where the area size of the face image is one of equal to and greater than the predetermined threshold value.

In an embodiment, a camera having a focus adjusting system and face recognition function is provided, including an image pickup device for capturing an object image formed via a photographing optical system including a focusing lens group which is movable along an optical axis; a face recognition device for recognizing face images based on the image signals; a focus adjusting device which performs a focus search process, wherein the image pickup device is activated to capture the object image at each of a plurality of different positions of the focusing lens group in the optical axis direction while the focusing lens group is moved along the optical axis to detect a focus state based on image signals of the object images obtained at the plurality of different positions of the focusing lens group; and a controller which determines an average value of areas of the face images recognized by the face recognition device, and controls the focus adjusting device so as to perform the focus search process so that the focusing lens group moves from a near extremity thereof toward a far extremity thereof in the case where the average value is one of equal to and greater than a predetermined value and so that the focusing lens group moves from the far extremity toward the near extremity if the average value is smaller than the predetermined value, when the face recognition device recognizes the face images.

According to another aspect of the present invention, when the face recognition device recognizes the face images of persons at different distances, the focus search process is performed so that the focusing lens group moves from the near extremity toward the far extremity if the average value of the areas of the recognized face images is equal to or greater than a predetermined value and so that the focusing lens group moves from the far extremity toward the near extremity if the average value is smaller than the predetermined value, and therefore, a focus point (in-focus position) on each face image can be searched and detected in a short period of time.

When the face recognition device recognizes the face images, it is desirable for the controller to control the focus adjusting device so as to detect a focus state on each of the areas of the face images recognized by the face recognition device to determine in-focus lens positions of the focusing lens group at which an in-focus state is achieved on the face images recognized by the face recognition device, respectively, and to control the image pickup device to as to perform an image capturing operation at each of the in-focus lens positions by moving the focusing lens group sequentially to the in-focus lens positions.

It is desirable for the controller to control the image pickup device so as to perform the image capturing operation on the recognized face images in a sequential order, starting from an in-focus lens position among the in-focus lens positions which is the closest to a stop position of the focusing lens group at a termination of the focus search process, and controls the image pickup device so as to perform the image capturing operation at each of the in-focus lens positions by moving the focusing lens group sequentially to the in-focus lens positions.

It is desirable for the predetermined value to be determined in accordance with a focal length of the photographing optical system to become greater as the focal length of the photographing optical system becomes longer.

When the face recognition device recognizes no face image, it is desirable for the focus detecting device to perform the focus search process based on an image signal of a face image formed in a predetermined focus detection area.

It is desirable for the camera to include a monitor which displays the object image captured by the image pickup device, wherein the controller sets focus detection areas to correspond to the face images recognized by the face recognition device, respectively, and the monitor displays square brackets which visually indicate the focus detection areas, the square brackets being superimposed on the face images, respectively.

When the image pickup device performs the image capturing operation at each of the in-focus lens positions while the focus detecting device moves the focusing lens group sequentially to the in-focus lens positions, it is desirable for the controller to make the monitor indicate in-focus frames which visually identify face images on which an in-focus state is achieved, respectively, every time the image pickup device performs the image capturing operation.

The present disclosure relates to subject matter contained in Japanese Patent Applications No. 2006-333721 (filed on Dec. 11, 2006) and No. 2007-146558 (filed on Jun. 1, 2007), which are expressly incorporated herein in their entireties.

### BRIEF DESCRIPTION OF THE DRAWINGS

The present invention will be discussed below in detail with reference to the accompanying drawings, in which:

FIG. 1 is a block diagram of elements of a first embodiment of a digital camera to which a focus adjusting system according to the present invention is applied, showing a basic configuration of the digital camera;

FIG. 2 is a diagrammatic illustration showing the relative positions of five focus detection areas on a light receiving surface of an image pickup device provided in the digital camera shown in FIG. 1;

FIG. 3 is a diagrammatic illustration showing the arrangement of primary-color filters of the image pickup device;

FIG. 4 is an illustration showing the relationship between a face image and a focus detection area in the two different cases where a person to be photographed is located at a short distance and a far distance, respectively;

FIGS. 5A and 5B show a manner of changing the search start extremity in accordance with variations in area size of a face image, wherein FIG. 5A shows an illustration showing the relationship between positions of the focusing lens group and contrast values when a person to be photographed is at a short distance and an associated graph showing a manner of movement of the focusing lens group when a focus search process is performed again; and FIG. 5B shows an illustration showing the relationship between positions of the focusing lens group L1 and contrast values when a person to be photographed is at a far distance and an associated graph showing a manner of movement of the focusing lens group when the focus search process is performed again;

FIGS. 6A, 6B and 6C are illustrations showing a manner of indication by an indicating device in a contrast AF process of the digital camera shown in FIG. 1, wherein FIG. 6A shows an indication at the commencement of the contrast AF process, FIG. 6B shows an indication during the contrast AF process when the face recognition function recognizes a face, and FIG. 6C shows an indication after an in-focus state is achieved on the face recognized by the face recognition function;

FIG. 7 is a flow chart showing a main process performed in the digital camera shown in FIG. 1;

FIG. 8 is a flow chart showing a sub-routine “Contrast AF Process” performed in the main process shown in FIG. 7.

FIG. 9 is a flow chart showing a sub-routine “focus initializing process” performed in the contrast AF process shown in FIG. 8;

FIG. 10 is a flow chart showing a sub-routine “focus detection area determining process” performed in the contrast AF process shown in FIG. 8;

FIGS. 11A and 11B are illustrations of the relationship between the locations of persons and the images thereof in a picture area when the persons are photographed, in a second embodiment of the digital camera to which the present invention is applied, wherein FIG. 11A shows the relationship between face images of two persons and the picture area when both the two persons are in a short distance range, and FIG. 11B shows the relationship between face images of three persons and the picture area when all the three persons are in a far distance range;

FIGS. 12A, 12B and 12C are illustrations of the relationship among face images of persons, focus detection areas and the picture area, wherein FIGS. 12A and 12B show this relationship in the case shown in FIGS. 11A and 11B, respectively, and FIG. 12C shows the relationship between focus detection areas and the picture area when no face image exits in the picture area;

FIGS. 13A, 13B, 13C and 13D are illustrations of the general outlines of a process performed in a face recognition AF mode in the case shown in FIG. 11A, wherein FIG. 13A is a view similar to that shown in FIG. 12A, FIGS. 13B and 13C are graphs showing a manner of detecting an in-focus state on face images of two persons (wherein the horizontal and vertical axes represent positions of the focusing lens group and contrast values, respectively), and FIG. 13D shows a manner of movement of the focusing lens group;

FIGS. 14A, 14B, 14C, 14D and 14E are illustrations of the general outlines of a process performed in the face recognition AF mode in the case shown in FIG. 12A, wherein FIG. 14A is a view similar to that shown in FIG. 13A, FIGS. 14B, 14C and 14D are graphs showing a manner of detecting an in-focus state of face images of three persons (wherein the horizontal and vertical axes represent positions of the focusing lens group and contrast values, respectively), and FIG. 14E is a manner of movement of the focusing lens group;

FIGS. 15A(a), 15A(b) and 15A(c) are illustrations showing a manner of indication by the indicating device in the contrast AF process of the second embodiment of the digital camera in the case shown in FIG. 11A when the face recognition function recognizes two faces, wherein FIG. 15A(a) shows an indication at the commencement of the contrast AF process, FIG. 15A(b) shows an indication upon a peak contrast value being detected in the image signal of one of the two face images, and FIG. 15A(c) shows an indication upon a peak contrast value being detected in the image signal of the other face image;

FIGS. 15B(a), 15B(b), 15B(c) and 15B (d) are illustrations showing a manner of indication by the indicating device in the contrast AF process of the second embodiment of the digital camera in the case shown in FIG. 11B when the face recognition function recognizes three faces, wherein FIG. 15B(a) shows an indication at the commencement of the contrast AF process, FIG. 15B(b) shows an indication upon a peak contrast value being detected in the image signal of one of the three face images, FIG. 15B(c) shows an indication upon a peak contrast value being detected in the image signal of another of the three face images, and FIG. 15B(d) shows an indication upon a peak contrast value being detected in the image signal of the other face image;

FIG. 16 is a flow chart showing a main process performed in the second embodiment of the digital camera;

FIGS. 17A and 17B are flow charts showing a sub-routine “face-recognition consecutive exposure process performed in the main process shown in FIG. 16; and

FIG. 18 is a flow chart showing a sub-routine “focus initializing process” performed in the face-recognition consecutive exposure process shown in FIG. 17A.

### DESCRIPTION OF THE PREFERRED EMBODIMENTS

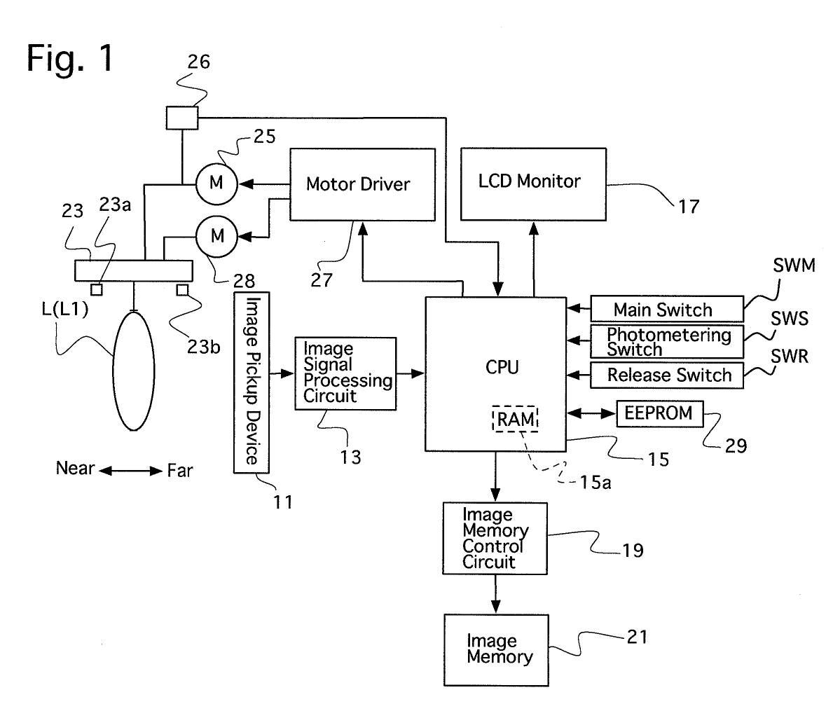

FIG. 1 is a block diagram of elements of a first embodiment of a compact digital camera having a contrast AF type of focus adjusting system (focusing system) to which the present invention is applied.

This digital camera is provided with a zoom lens (photographing optical system) L including a focusing lens group L1, and an image pickup device (CCD image sensor) 11. An object image is formed on a light receiving surface 12 of the image pickup device 11 via the zoom lens L. The image pickup device 11 includes a large number of pixels (photoelectric transducing elements) arranged in a two-dimensional matrix at predetermined intervals. The digital camera is further provided with an image signal processing circuit 13, a CPU 15, an LCD monitor 17, an image memory control circuit 19, and an image memory 21. Each pixel of the image pickup device 11 converts the incident light of an object image thereon into an electrical charge, and the electrical charges are accumulated (integrated). Upon completion of an exposure, the accumulated charges are output, pixel by pixel, as an image signal to the image signal processing circuit 13.

The image signal processing circuit 13 performs predetermined adjusting processes such as a white-balance adjusting process and an A/D converting process on the input image signal to output digital image data to the CPU 15. Namely, image data to which a predetermined process has been given and converted into digital image data in units of pixels are output to the CPU 15. In a ready-to-photograph state with the power ON, the CPU 15 operates in a through mode (monitoring mode) in which the CPU 15 operates to convert the regularly-input image data into an image signal capable of being indicated on the LCD monitor 17 to visually indicate the image data on the LCD monitor 17. Additionally, upon a release switch SWR which is connected to the CPU 15 being turned ON, the CPU 15 captures an object image based on settings such as a f-number and a shutter speed and converts the input image data into image data having a predetermined format to write this image data into the image memory 21 via the image memory control circuit 19. The digital camera is further provided with an EEPROM 29 serving as a nonvolatile memory which is connected to the CPU 15. A predetermined format, variable data and others are written in the EEPROM 29.

The digital camera is provided with different contrast AF modes: a face-recognition AF mode, a multi-point AF mode, and a spot AF mode. In the face-recognition AF mode, a face image is recognized and taken as a focus detection area, and a focal point is searched on the focus detection area to bring the recognized face image into focus. In the multi-point AF. mode, with the face recognition function not activated, a focal point is searched on each of a plurality of focus detection areas to bring one or more object images within the focus detection areas which satisfy predetermined conditions into focus. In the spot AF mode, with the face recognition function not activated, a focal point is searched on a central focus detection area to bring an object image within the central focus detection area into focus.

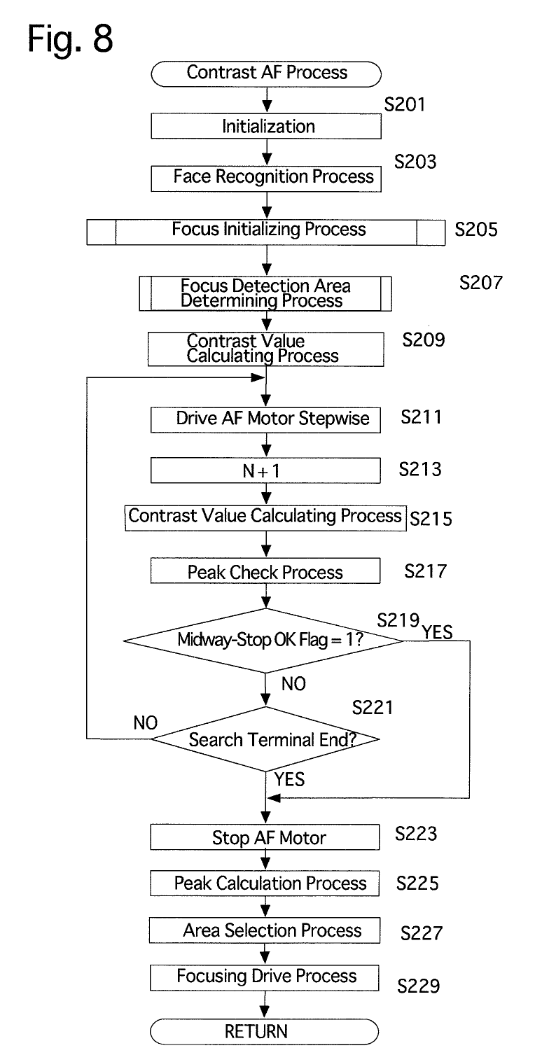

In the multi-point AF mode or the spot AF mode, upon a photometering switch SWS which is connected to the CPU 15 being turned ON, the CPU 15 captures images consecutively via the image pickup device 11 while moving the focusing lens group L1 stepwise from the closest (shortest) focus position (near extremity/position for bringing an object at the shortest distance in working range into focus) to the infinite focus position (far extremity/position for bringing an object at infinity into focus), or vice versa, stores the captured images in an internal RAM 15a of the CPU 15, and detects the contrasts (contrast values) of the captured images in each focus detection area. Thereafter, a peak contrast value is detected in each focus detection area to detect the position of the focusing lens group L1 at which this peak contrast value is obtained, i.e., an in-focus lens position of the focusing lens group L1 is obtained. Thereupon, the focusing lens group L1 is moved to the in-focus lens position thus obtained. Both images captured during a contrast AF process (see FIG. 8) and images captured after an in-focus state is achieved are normally indicated on the LCD monitor 17 in the through mode.

The digital camera is provided therein with a lens drive mechanism 23 and a zoom motor 28 for driving the zoom lens L via the lens drive mechanism 23. The focal length of the zoom lens L is detected by an encoder (not shown) incorporated in the lens drive mechanism 23.

Primary-color filters (red (R), green (G) and blue (B) filters) are disposed in front of each pixel (photoelectric transducing element) on the object side thereof, and each pixel on the light receiving surface 12 transduces the red, green and blue components of the incident rays of object light that are passed through the primary-color filters into electrical charges, and these electrical charges are accumulated. The electrical charges thus accumulated for a predetermined period of time are read out of the image pickup device 11 pixel by pixel to be output as an image signal.

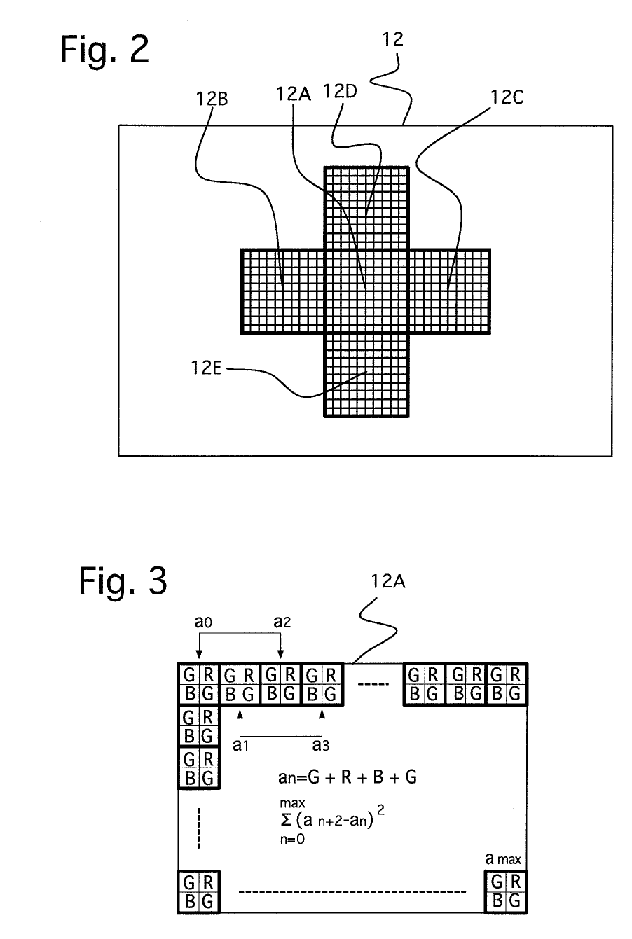

FIG. 2 shows the relative position between the light receiving surface 12 of the image pickup device 11 and five focus detection areas: first through fifth focus detection areas 12A, 12B, 12C, 12D and 12E, arranged on the light receiving surface 12 in the shape of a cross, by way of example. FIG. 3 is an enlarged view of the first (central) focus detection area 12A. Each of the remaining four focus detection areas 12B through 12E has the same structure as the first focus detection area 12A, and accordingly, only the first focus detection area 12A is shown in FIG. 3. The first focus detection area 12A is positioned at substantially the center of the light receiving surface 12, the second and third focus detection areas 12B and 12C are positioned on laterally opposite sides of the first focus detection area 12A, and the fourth and fifth focus detection areas 12D and 12E are positioned on vertically opposite sides of the first focus detection area 12A. Primary-color filters (red (R), green (G) and blue (B) filters) are disposed in front of each pixel (photoelectric transducing element) on the object side thereof, and each pixel on the light receiving surface 12 transduces the red, green and blue components of the incident rays of object light that are passed through the primary-color filters into electrical charges, and these electrical charges are accumulated. The electrical charges thus accumulated for a predetermined period of time are read out of the image pickup device 11 pixel by pixel to be output as an image signal.

FIG. 3 shows a typical arrangement (Bayer array) of primary-color filters. In the contrast AF process in the illustrated embodiment of the digital camera, four pixels (a 2 by 2 matrix of pixels) in each square (i.e., a combination of two green filters, a red filter and a blue filter) is treated as one pixel block, and the sum of the magnitudes of image signals integrated by the four pixels in each pixel block is regarded as intensity aₙ (aₙ=G+R+B+G).

Accordingly, an operation for determining the difference between the intensity aₙ of a pixel block and the intensity aₙ of another pixel block positioned one pixel-block away from the previous pixel block in the horizontal direction is repeated successively in the horizontally rightward direction within the first focus detection area 12A while the differences thus determined (aₙ₊₂−aₙ) are added up. Upon completion of the difference determining and adding operations on the pixel block at the right end of the first focus detection area 12A in the horizontal direction, the difference determining and adding operations are repeated on a subsequent row of pixel blocks one pixel block below the previous row of pixel blocks in the vertical direction until completion of the determining operation on the pixel block at the right end of the first focus detection area 12A in the horizontal direction and completion of the adding operation thereof. Such difference determining and adding operations are repeated on all the pixel blocks in the first focus detection area 12A. Subsequently, the same operations are performed on each of the remaining four focus detection areas 12B through 12E.

The sum of the differences (aₙ₊₂−aₙ) on each of the first through fifth focus detection areas 12A through 12E corresponds to the contrast value in the focus detection area at the current position of the focusing lens group L1.

The first embodiment of the digital camera has a function (face recognition function) of recognizing a face image, focuses, and performs exposure compensation when capturing images. More specifically, the CPU 15 determines whether or not an image signal of a face image is included in an image signal (image data) written into the internal RAM 15a of the CPU 15 after an object image is captured via the image pickup device. The face recognition (face detection) is carried out according to a known method. Namely, in face recognition, flesh color (skin color) or face feature points (e.g., eye points, nose points and mouth points) are detected or the contours of a person's face are extracted to recognize a face image in the entire image signal captured by the image pickup device 11. In the face recognition AF mode in the first embodiment of the digital camera, upon recognizing a face image, the CPU 15 determines the position of an image area including the face image to set a focus detection area 12F with the center thereof coincident with the center of this image area, and determines an in-focus position (in-focus lens position of the focusing lens group L1) from the image signal of an object image included in the focus detection area 12F. In the face recognition AF mode in the first embodiment of the digital camera, the size of the focus detection area 12F is fixed, and the position of the focus detection area 12F is set to be centered with respect to a recognized face image.

The first embodiment of the face recognition AF mode, which is a feature of the first embodiment of the digital camera, will be discussed hereinafter. In the first embodiment of the face recognition AF mode, a face image is recognized and a focusing process is performed on an object image formed in the focus detection area 12F which includes the recognized face image. In the case where no face image is recognized, or in the case where the digital camera is in the multi-point AF mode or the spot AF mode, a focusing process is performed on an object image formed in a predetermined focus detection area among the five focus detection areas 12A through 12E.

In the first embodiment of the face recognition AF mode, before the aforementioned focus search process is performed, a face recognition process (see step S203 shown in FIG. 8) is performed to determine whether or not a face image signal which corresponds to a face image is included in an image signal of an image captured by the image pickup device 11. If it is determined that such a face image signal is included, it is determined whether or not the area size of the recognized face image is greater than a threshold value which is predetermined according to the focal length of the zoom lens L. If the area size of the recognized face image is equal to or greater than the predetermined threshold value, the object to be photographed is positioned at a short distance, and accordingly, the focus search process is performed with the near extremity (closest focus position) of the focusing lens group L1 being set as a search start extremity from which the focusing lens group L1 starts moving to bring the object at a short distance into focus. If the area size of the recognized face image is smaller than the predetermined threshold value, the object to be photographed is positioned at a far distance, and accordingly, the focus search process is performed with the far extremity (closest focus position) of the focusing lens group L1 being set as the aforementioned search start extremity. One threshold value is selected and set from among different predetermined threshold values according to the currently-set focal length of the zoom lens L because the area size of the face image increases as the focal length of the zoom lens L increases even if the object of the recognized face image remains at the same distance. Such different predetermined threshold values are stored in advance in the EEPROM 29 for different ranges of the entire zooming range (different ranges of variable focal length), respectively. However, it is possible for there to be only one threshold value, and for this threshold value to be corrected by a correction factor according to the number of steps of the stepped zooming range, or that the area size of the recognized face image be corrected by a correction factor.

When no face image is recognized, the CPU 11 detects an in-focus position using either image signals of five object images captured in the first through fifth focus detection area 12A through 12E, respectively or an image signal of an object image captured in a set focus detection area among the first through fifth focus detection area 12A through 12E.

In the present embodiment of the digital camera, the position (lens position) of the focusing lens group L1 in the optical axis direction is detected using two origin sensors 23a and 23b with the closest focus position (near extremity) and the infinite focus position (far extremity) of the focusing lens group L1 being predetermined as two points of origin, respectively, and is counted as the number of drive pulses from either point of origin. The drive pulses are defined as, e.g., pulses output from an encoder 26 such as a photo-interrupter installed on the output shaft of the AF motor 25. Although several hundreds of pulses or more are usually necessary for driving the focusing lens group L1 from the closest focus position to the infinite focus position, it is assumed that several pulses or several dozen pulses are only necessary for driving the focusing lens group L1 (while capturing images) in a stepwise manner from the closest focus position to the infinite focus position in the contrast AF process in the present embodiment of the digital camera for the purpose of simplifying the description, and that one step corresponds to one drive pulse and one lens-position pulse.

In addition, in the present embodiment of the digital camera, the position of the focusing lens group L1 is represented by a lens-position pulse number (variable) PN which is incremented by one every time the encoder 26 outputs one pulse (drive pulse) when the AF motor 25 is driven in the direction from the closest focus position to the infinite focus position, and the lens-position pulse number PN is 0 when the focusing lens group L1 is positioned at the initial position thereof (closest focus position in the present embodiment of the digital camera). In either of the two cases where a focus search operation in which the focusing lens group L1 is moved from the closest focus position to the infinite focus position is performed and where a focus search operation in which the focusing lens group L1 is moved from the infinite focus position to the closest focus position is performed, the lens-position pulse number at the initial position of the focusing lens group L1 is set to 0, and the lens-position pulse number at the infinite position of the focusing lens group L1 is set to a maximum value, the lens-position pulse numbers are added up when the focusing lens group L1 is driven stepwise from the initial position thereof to another position, and a lens-position pulse number is subtracted from the lens-position pulse numbers thus added up step by step when the focusing lens group L1 is driven stepwise in the opposite direction toward the initial position thereof.

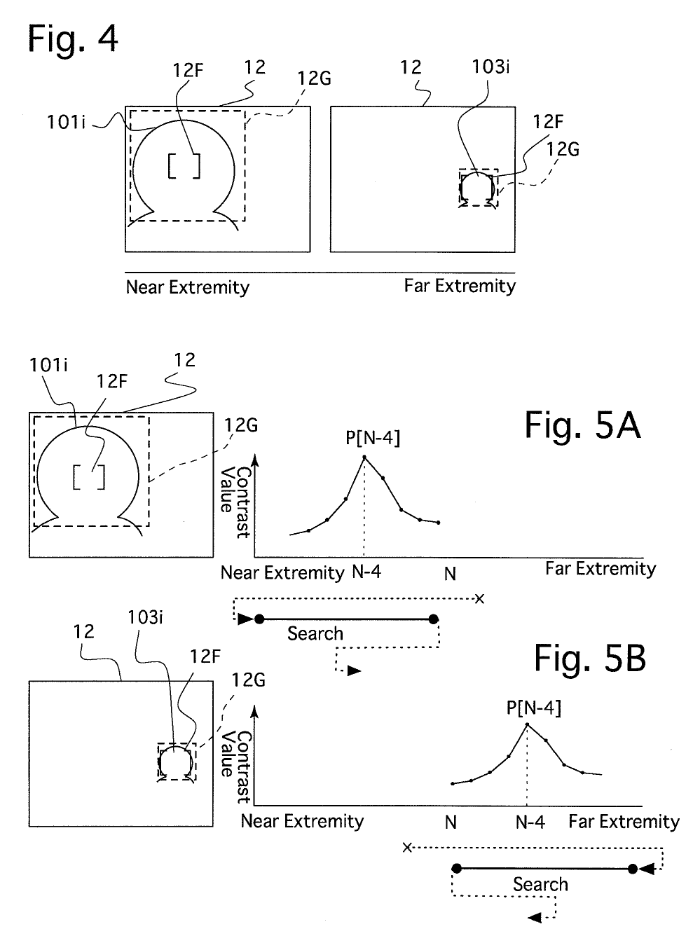

FIG. 4 shows the relationship among a face image 101i of a person, the focus detection area 12F and a face recognition area 12G when the person is at a short distance, and the relationship among a face image 103i of a person, the focus detection area 12F and the face recognition area 12G when the person is at a far distance. If the face image 101i and the face image 103i are those of the same person, it can be seen clearly from FIG. 4 that the face image 101i at the time the person is at a short distance is larger than the face image 103i at the time the person is at a far distance.

FIGS. 5A and 5B show a manner of changing the search start extremity in accordance with variations in area size of the face image (face recognition area 12G). FIG. 5A shows an illustration showing the relationship between positions of the focusing lens group L1 and contrast values when a person as an object to be photographed is at a short distance and an associated graph showing a manner of movement of the focusing lens group L1 when the focus search process is performed again; and FIG. 5B shows an illustration showing the relationship between positions of the focusing lens group L1 and contrast values when a person as an object to be photographed is at a far distance and an associated graph showing a manner of movement of the focusing lens group L1 when the focus search process is performed again. In each graph shown in FIGS. 5A and 5B, the position shown by a letter “x” designates the position of the focusing lens group L1 at the commencement of the contrast AF process.

When the face image 101i (face recognition area 12G) that is equal to or greater than a predetermined threshold value is recognized by the face recognition process (see step S203 shown in FIG. 8), the focus detection area 12F is set so that the center thereof is positioned at an approximate center of the face image 101, the focusing lens group L1 is moved to the near extremity, and the focus search process is performed so that the focusing lens group L1 is driven toward the far extremity with the near extremity and the far extremity set as the search start extremity and the search end extremity, respectively (see FIG. 5A). Thereafter, upon a peak contrast value being detected in the image signal of an image formed in the focus detection area 12F, the focus search process is terminated, the focusing lens group L1 is moved to a lens position thereof at which the peak contrast value is detected, and thereupon the contrast AF process ends.

When the face image 103i (face recognition area 12G) that is smaller than the predetermined threshold value is recognized by the face recognition process, the focus detection area 12F is set so that the center thereof is positioned at an approximate center of the face image 103, the focusing lens group L1 is moved to the far extremity, and the focus search process is performed so that the focusing lens group L1 is driven toward the near extremity with the near extremity and the far extremity set as the search end extremity and the search start extremity, respectively (see FIG. 5B). Thereafter, upon a peak contrast value being detected in the image signal of an image formed in the focus detection area 12F, the focus search process is terminated, the focusing lens group L1 is moved to a lens position thereof at which the peak contrast value is detected, and thereupon the contrast AF process ends.

According to the contrast AF process in the first embodiment of the digital camera, as can also be seen from FIGS. 5A and 5B, the object distance of a person (object) to be photographed is determined from the area size of the recognized face image of the person, and the focus search process starts from the near extremity of the focusing lens group L1 if the person is positioned at a short distance when the recognized face image is equal to or greater than the predetermined threshold value, or the focus search process starts from the far extremity of the focusing lens group L1 if the person is positioned at a far distance when the recognized face image is smaller than the predetermined threshold value, which reduces the time required to detect a peak contrast value, thus making it possible to reduce the total time required to bring the recognized face image into focus.

In the first embodiment of the digital camera, when the face image 101i is greater than the predetermined threshold value, e.g., when the area of the face image 101i is equal to or greater than ½ of the picture area (which corresponds to the light receiving surface 12 and the screen of the LCD monitor 17), it is determined that the object (person of the face image 101) is at a short distance. If the focal length is longer than that in the case shown in FIGS. 5A and 5B, it is determined that the object is at a short distance in accordance with variations in focal length when the area of the face image 101i is equal to or greater than ⅔, ¾, etc., of the picture area. If the focal length is shorter than that in the case shown in FIGS. 5A and 5B, it is determined that the object is at a short distance in accordance with variations in focal length when the area of the face image 101i is equal to or greater than ⅓, ¼, etc., of the picture area.

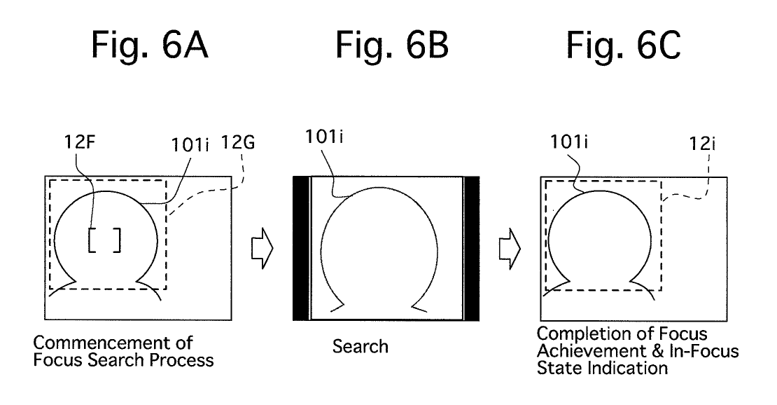

In the first embodiment of the digital camera, upon a face image being recognized in the contrast AF process, a zoom-in image (magnified image) of this face image is indicated on the LCD monitor 17. FIGS. 6A, 6B and 6C show this indication manner. FIG. 6A shows an image (video image) in the through mode at the commencement of the contrast AF process. In the first embodiment of the digital camera, the face image 101i is assumed to be indicated on the LCD monitor 17 as shown in FIG. 6A, and the face image 101i is assumed to have been recognized by the face recognition process upon the commencement of the contrast AF process. The CPU 15 trims the image (which includes the face image 101) indicated on the LCD monitor 17 to indicate the face image 101i as a zoom-in image (magnified image) as shown in FIG. 6B. In the first embodiment of the digital camera, the face image 101i is cut from the whole image indicated on the LCD monitor 17 with an aspect ratio of 1 to 1 to be fully magnified to the upper and lower edges of the rectangular picture area. The face image 101i remains indicated in this zoom-in indication manner as shown in FIG. 6B during the focus search process. This zoom-in indication manner makes it possible for the user to visually confirm which object will be brought into focus.

Upon completion of the contrast AF process, the manner of indication of the LCD monitor 17 is switched back to the normal manner (in which a non-trimmed image of the entire image signal captured by the image pickup device 11 is indicated), and thereupon, a highlighted frame 12i which surrounds the face image 101i is indicated on the LCD monitor 17 as an in-focus indication which indicates that the object surrounded by the highlighted frame 12i is currently in-focus (see FIG. 6C). With the highlighted frame 12i, the user can visually recognize which part of the image is currently in-focus. Instead of the highlighted frame 12i, a boundary line of the focus detection area 12F (e.g., left and right square brackets indicating the focus detection area 12F) can be highlighted since the user only needs to be able to visually recognize a currently in-focus part of the image indicated on the LCD panel 17.

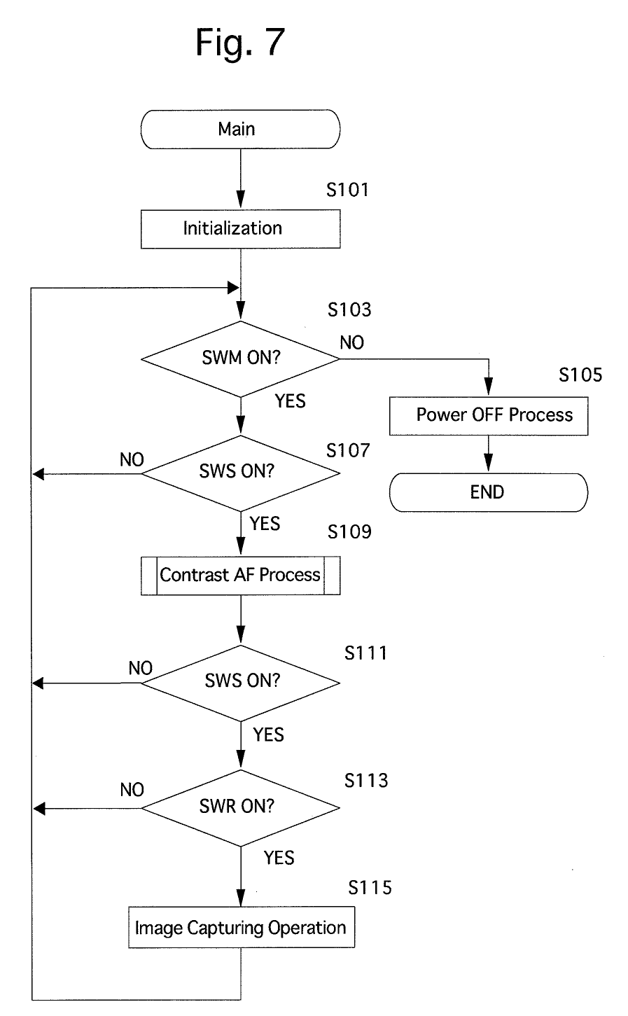

Operations of the contrast AF process performed in the first embodiment of the digital camera will be discussed in detail with reference to the flow charts shown in FIGS. 7 through 10. FIG. 7 is a flow chart showing an embodiment of a main process having a sequence of operating steps which is performed in this digital camera. Control enters this main process upon a battery (not shown) being loaded into the digital camera.

In the main process, firstly the CPU 15 performs an initializing process for initializing the internal RAM 15a and various ports of the CPU 15 (step S101). Subsequently, it is determined whether or not the main switch SWM is ON (step S103). If the main switch is not ON (if NO at step S103), power is turned OFF (step S105) and control ends. Thereafter, the CPU 15 is periodically activated to check the ON/OFF state of the main switch SWM (step S103).

If the main switch is ON (if YES at step S103), it is determined whether or not the photometering switch SWS is ON (step S107). If the photometering switch SWS is ON (if YES at step S107), the contrast AF process (see FIG. 8) is performed (step S109). Upon completion of the contrast AF process, it is again determined whether or not the photometering switch SWS is ON (step S111). If the photometering switch SWS is ON (if YES at step S111), it is determined whether or not the release switch SWR is ON (step S113). If the release switch SWR is ON (if YES at step S113), an image capturing operation (operation for capturing an object image by an image pickup device 11) is performed (step S115) and control returns to step S103. If the release switch SWR is not ON (if NO at step S113), control simply returns to step S103.

If it is determined at step S107 or Sill that the photometering switch SWS is not ON, control returns to step S103.

The contrast AF process that is performed at step S109 will be hereinafter discussed in detail with reference to the flow chart shown in FIG. 8.

In the contrast AF process, firstly various variables, etc., are initialized (step S201). For instance, in the first embodiment of the digital camera, each status (flag) is cleared (i.e., set to 0), contrast values are cleared, a lens-position pulse number N is initialized (N=0), the maximum contrast value is set to 0, the minimum contrast value is set to FFFFFFFF, a midway-stop OK flag is cleared, and a face recognition flag is cleared.

Variables are defined as follows.

Contrast values are those actually obtained at each focus detection area.

The maximum contrast value and the minimum contrast value are variables to which actually obtained maximum and minimum contrast values are assigned, respectively.

Given that the lens-position pulse number N is 0 when the focusing lens group L1 is positioned at one of the closest focus position and the infinite focus position which serves as the initial position of the focusing lens group L1, the lens-position pulse number N is a variable which is incremented by one every time the encoder 26 outputs one pulse (drive pulse) when the AF motor 25 is driven in the direction toward the other of the closest focus position and the infinite focus position. The CPU 15 recognizes the position of the focusing lens group L1 by counting this variable as the lens-position pulse number N.

The midway-stop OK flag (StopOK flag) is a flag which enables or, disables the focus search operation. Specifically, the midway-stop OK flags “0” and “1” disable and enable the focus search operation, respectively.

The face recognition flag is a flag which indicates whether or not a face image has been recognized. Specifically, the face recognition flags “0” indicates that no face image has been recognized and “1” indicates that a face image has been recognized.

Subsequently, the face recognition process is carried out to recognize a face image using a read-in image signal (step S203). A known face recognition method is adopted as the face recognition process performed at step S203. Upon a face image being recognized by this face recognition process, the face recognition flag is set to “1”.

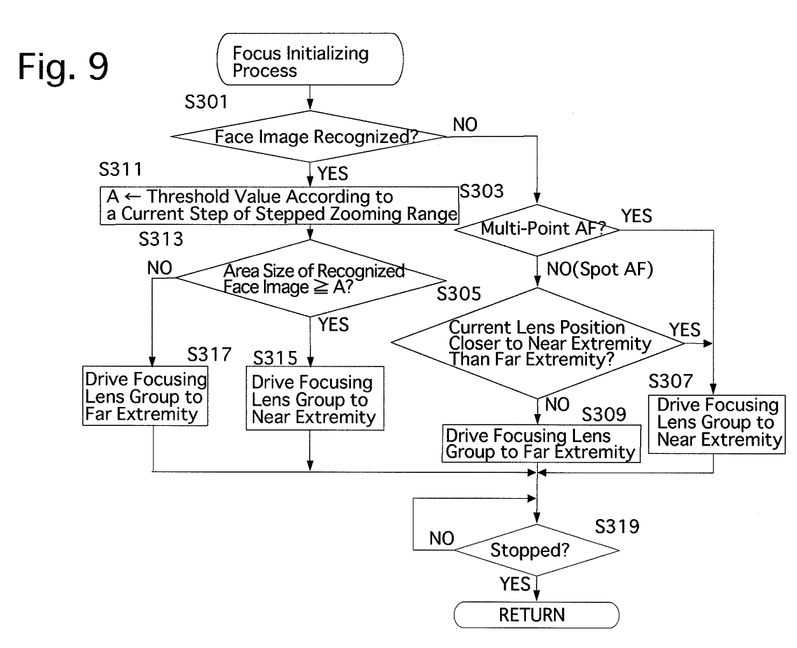

Subsequently, a focus initializing process (see FIG. 9) is performed (step S205). In this focus initializing process, the focusing lens group L1 is moved to either the near extremity or the far extremity in accordance with the determinations whether or not certain conditions are satisfied, e.g., the determination whether or not a face image has been recognized and the determination whether or not the currently-set AF mode is a multi-point AF mode. When a face image is recognized, the focusing lens group L1 is moved to the near extremity if the area size of the recognized face image is equal to or greater than the predetermined threshold value, or the focusing lens group L1 is moved to the far extremity if the area size of the recognized face image is smaller than the predetermined threshold value. When no face image is recognized, the focusing lens group L1 is moved to the near extremity if the currently-set AF mode is the multi-point AF mode. When no face image is recognized and the currently-set AF mode is not the multi-point AF mode (i.e., if the currently-set AF mode is the spot AF mode), the focusing lens group L1 is moved to the near extremity if positioned closer to the near extremity and the focusing lens group L1 is moved to the far extremity if positioned closer to the far extremity.

Subsequently, a focus detection area determining process is performed (step S207). If a face image is recognized in the face recognition process at step S203, information on the position of the recognized face image is obtained and the focus detection area 12F is set to be centered with respect to the recognized face image in the focus detection area determining process. If no face image is recognized in the face recognition process at step S203, all the five fixed focus detection areas 12A, 12B, 12C, 12D and 12E are selected in the focus detection area determining process.

Thereafter, an image capturing operation is performed to capture an image signal of an image in each focus detection area set at step S207 at the search start extremity of the focusing lens group L1, and a contrast value calculating process is performed (step S209). Namely, based on the image data input from the image pickup device 11, the contrast value P[0] at the initial position of the focusing lens group L1 is calculated, and the maximum contrast value Max and the minimum contrast value Min are updated.

Subsequently, the AF motor 25 is driven by one step in the direction to move the focusing lens group L1 toward the search end extremity (step S211), and the lens-position pulse number N is incremented by one in accordance with the direction of movement of the focusing lens group L1 (step S213). Thereafter, a contrast value calculating process is performed (step S215). In this contrast value calculating process, a contrast value P[N] is calculated in accordance with the image signal captured from the image pickup device 11, and the maximum contrast value and the minimum contrast value are updated. Subsequently, a peak check process is performed which determines whether or not the contrast value P[N] calculated at step S215 is a peak contrast value which satisfies preset conditions (step S217). Although the peak check process can use a known algorithm, in the first embodiment, it is determined whether or not the central contrast value among a group of nine contrast values respectively calculated at immediate consecutive nine positions of the focusing lens group L1 at each focus detection area set at step S207 is a peak contrast value. Thereupon, if a peak contrast value is obtained in the face recognition AF mode and the spot AF mode, the midway-stop OK flag (StopOK flag) is set to “1”.

Subsequently, it is determined whether or not the midway-stop OK flag is “1” (step S219). If the midway-stop OK flag is not “1” (if NO at step S219), it is determined whether or not the focusing lens group L1 has reached the search end extremity (step S221). If the focusing lens group L1 has not reached the search end extremity (if NO at step S221), control returns to step S211 so that the above described operations at steps S211 through S219 are repeated.

If the midway-stop OK flag is “1” (if YES at step S219) or if the focusing lens group L1 has reached the search end extremity (if YES at step S221), the AF motor 25 is stopped (step S223). Subsequently, a peak calculation process for calculating a peak contrast value (by linear approximation) is performed in accordance with the nine contrast values at consecutive nine lens positions (atone of which a peak contrast value has been obtained) which are obtained in the loop process at steps S211 through S221 (step S225). Namely, an estimated more precise peak contrast value and the position of the focusing lens group L1, at which this estimated more precise peak contrast value is obtained, are calculated by linear approximation because there is a possibility of a real peak contrast value existing in the vicinity of a peak contrast value among the contrast values respectively calculated at the stepwise stop positions of the focusing lens group L1.

Subsequently, an area selection process is performed at step S227. In the area selection process, one of the focus detection areas in which a value at the closest distance is obtained in accordance with the peak contrast value obtained at each focus detection area is selected as an in-focus area in the multi-point distance measuring mode (step S227), and a focusing drive process is performed in which the focusing lens group L1 is moved to the lens position thereof at which a peak contrast value is obtained in this in-focus area (step S229). Thereafter, the contrast AF process ends.

In the above described contrast AF process, if a face image is recognized by the face recognition process at step S203, the manner of indication of the LCD monitor 17 is switched to the aforementioned zoom-in indication manner in which an image of the image signal obtained from the area of the recognized face image is zoomed in to be indicated on the LCD 17 monitor as a zoom-in image (FIG. 6B), and subsequently, the manner of indication of the LCD monitor 17 is switched back to the aforementioned normal manner (FIG. 6C) upon completion of the focusing drive process at step S229.

### [Focus Initializing Process]

The focus initializing process that is performed at step S205 in the contrast AF process will be hereinafter discussed in detail with reference further to the flow chart shown in FIG. 9.

In the focus initializing process, firstly it is determined whether or not a face image has been recognized at the face recognition process at step S203 (step S301). If no face image has been recognized (if NO at step S301), it is determined whether or not the currently-set AF mode is the multi-point AF mode (step S303). If the currently-set AF mode is the multi-point AF mode (if YES at step S303), the AF motor 25 is driven to move the focusing lens group L1 to the near extremity (step S307). In the multi-point AF mode, the search start extremity and the search end extremity of the focusing lens group L1 are set to the near extremity and the far extremity of the focusing lens group L1, respectively. If the currently-set AF mode is not the multi-point AF mode, i.e., if the currently-set AF mode is the spot AF mode (if NO at step S303), it is determined whether or not the focusing lens group L1 is closer to the near extremity than the far extremity (step S305). If the focusing lens group L1 is closer to the near extremity than the far extremity (if YES at step S305), the AF motor 25 is driven to move the focusing lens group L1 to the near extremity (step S307). If the focusing lens group L1 is not closer to the near extremity than the far extremity (if NO at step S305), the AF motor 25 is driven to move the focusing lens group L1 to the far extremity (step S309). Thereafter, control waits for the focusing lens group L1 to reach the search end extremity (the near extremity or the far extremity) to thereby stop the AF motor 25 (if NO at step S319). Immediately after the AF motor 25 stops rotating (if YES at step S319), control returns.

On the other hand, if a face image has been recognized at the face recognition process at step S203 (if YES at step S301), a threshold value according to the current step of the stepped zooming range is set to a threshold value A (step S311), and subsequently, it is determined whether or not the size of the face recognition area 12G is equal to or greater than the threshold value A (step S313). If the size of the face recognition area 12G is equal to or greater than the threshold value A (if YES at step S313), the AF motor 25 is driven to move the focusing lens group L1 to the near extremity (step S315). If the size of the face recognition area 12G is not equal to or greater than the threshold value A (if NO at step S313), the AF motor 25 is driven to move the focusing lens group L1 to the far extremity (step S317). Thereafter, control waits for the focusing lens group L1 to reach the search end extremity (the near extremity or the far extremity) to thereby stop the AF motor 25 (if NO at step S319). Immediately after the AF motor 25 stops rotating (if YES at step S319), control returns.

The near extremity and the far extremity of the focusing lens group L1 serve as the search start extremity and the search end extremity, respectively, if the focusing lens group L1 is moved to the near extremity at steps S307 and S315. Conversely, the far extremity and the near extremity of the focusing lens group L1 serve as the search start extremity and the search end extremity, respectively, if the focusing lens group L1 is moved to the far extremity at steps S309 and S317.

### [Focus Detection Area Determination Process]

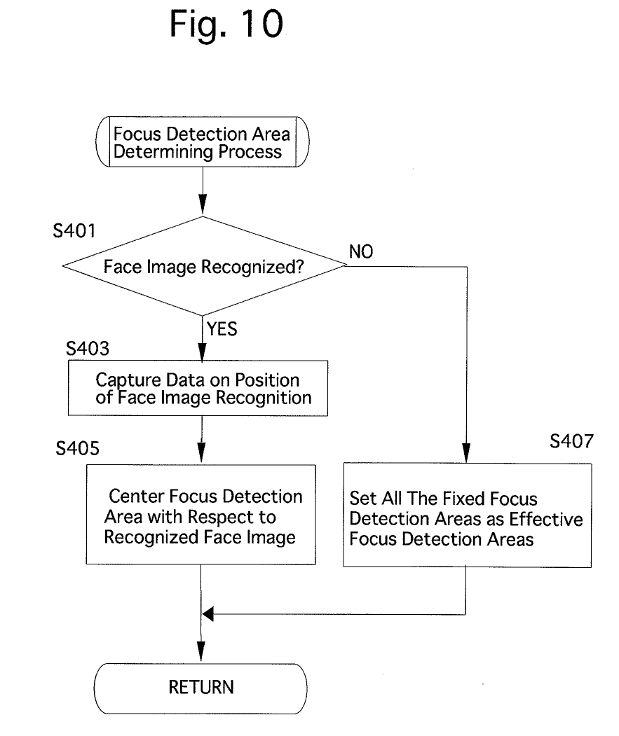

The focus detection area determination process that is performed at step S207 will be discussed in detail with reference to the flow chart shown in FIG. 10. In this process, firstly it is determined whether or not a face image has been recognized at the face recognition process at step S203 (step S401). If no face image has been recognized (if NO at step S401), all the five fixed focus detection areas 12A, 12B, 12C, 12D and 12E are selected as effective focus detection areas (step S407). If a face image has been recognized (if YES at step S401), data on the position at which the face image has been recognized is captured (step S403), the focus detection area 12F is centered at the recognized face image (step S405), and control returns.

The second embodiment the second embodiment of the digital camera will be discussed hereinafter. The second embodiment of the digital camera has a continuous face-recognition photographing mode. In the continuous face-recognition photographing mode, when two or more face images are recognized, a focusing operation and an image capturing operation are performed sequentially on each of the recognized face images. In the continuous face-recognition photographing mode, the face recognition is also carried out according to a known method. Namely, in the face recognition, flesh color (skin color) or face feature points (e.g., eye points, nose points and mouth points) are detected or the contours of faces are extracted to recognize faces in the entire image signal captured by the image pickup device 11. When the digital camera is in the continuous face-recognition photographing mode, upon detection of face images, the CPU 15 determines the positions of image areas including the face images to set focus detection areas with the centers thereof coincident with the centers of the image areas, respectively, and performs the focus search process on each of the set focus detection areas. Thereupon, an image capturing operation is performed sequentially on the face images in the set focus detection areas by moving the focusing lens group L1 sequentially to in-focus lens positions thereof on the face images.

When no face image is recognized, the focus search process is performed on object images in predetermined focus detection areas, respectively, and among object images within the focus detection areas on which in-focus lens positions of the focusing lens group L1 are detected, an object image in one focus detection area which is selected from among the predetermined focus detection areas according to preset conditions is brought into focus and an image capturing operation is performed.

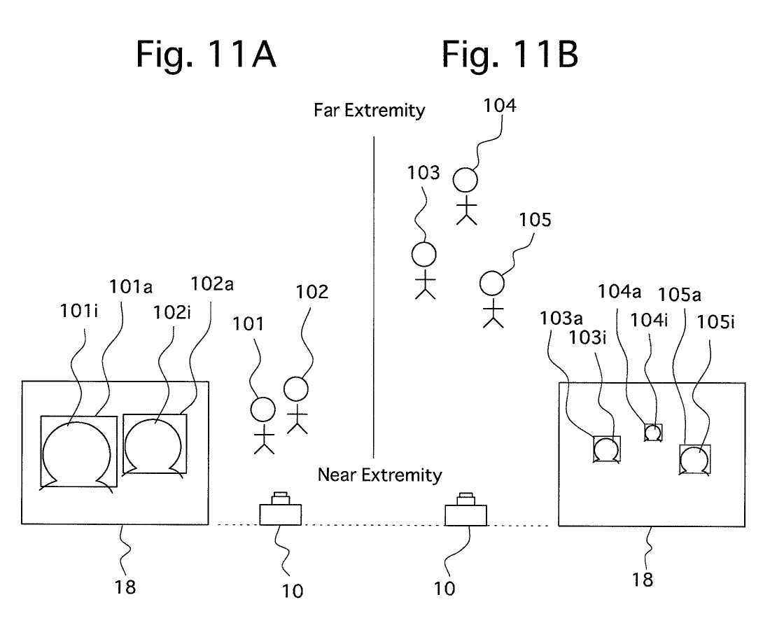

FIGS. 11A and 11B each show the relative position between the second embodiment of the digital camera 10 and persons to be photographed, and a manner of indicating the captured face images thereof on the LCD monitor 17. FIG. 11A shows the relationship between the screen 18 of the LCD monitor 17 and face images 101i and 102i of two persons 101 and 102, and areas (square areas) 101a and 102a which include the face images 101i and 102i, respectively, when the two persons 101 and 102 are in a short distance range. FIG. 11B shows the relationship between the screen 18 and face images 103i, 104i and 105i of three persons 103, 104 and 105, and areas (square areas) 103a, 104a and 105a which include the face images 103i, 104i and 105i, respectively, when the three persons 103, 104 and 105 are in a far distance range. As can be seen from these drawings, the face images 101i and 102i of the two persons 101 and 102, which are located closer to the digital camera 10 than the three persons 103, 104 and 105, are indicated on the LCD monitor 17 as larger images than the face images 103i, 104i and 105i of the three persons 103, 104 and 105 if the sizes of persons (the faces thereof) to be photographed are the same.

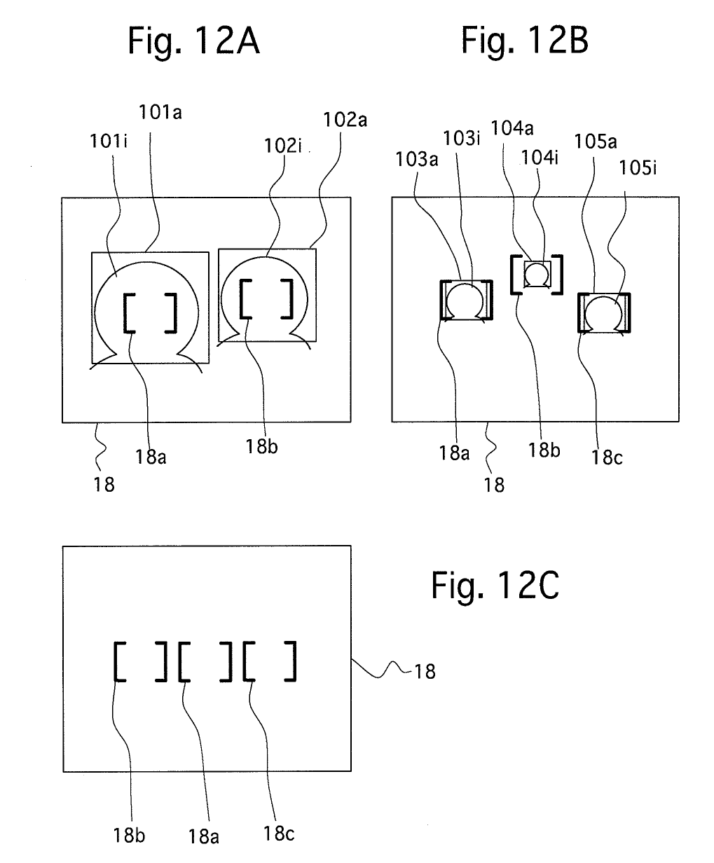

In the face recognition process in the second embodiment of the digital camera, a face image having a larger area size than a predetermined size is recognized as a face image. FIGS. 12A and 12B each show a manner of indication of the LCD monitor 17 by way of example, wherein two focus detection areas 18a and 18b are set so that the centers thereof are positioned at approximate centers of the face images 101i and 102i, respectively, and three focus detection areas 18a, 18b and 18c are set so that the centers thereof are positioned at approximate centers of the face images 103i, 104i and 105i, respectively. In the present embodiment of the digital camera 10, three focus detection areas 18a, 18b and 18c can be set in the picture area, and fixed positions of the three focus detection areas 18a, 18b and 18c are preset as shown in FIG. 12C; namely, the focus detection area 18a is centered in the screen 18 and the remaining two detection areas 18b and 18c are positioned on the left and right sides of the focus detection area 18a, respectively. Upon one or more face images being recognized, the positions of the focus detection areas 18a, 18b and 18c relative to the recognized face images are determined (see FIGS. 12A through 12C). The positions of the focus detection areas 18a, 18b and 18c relative to the recognized face images are determined so that each focus detection area includes an approximate main part of the associated recognized face image and so that the center of each focus detection area is substantially coincident with the center of the approximate main part of the associated recognized face image. In the face recognition process in the second embodiment of the digital camera, the focus detection areas 18a, 18b and 18c are set in the order of recognition of face images. In the drawings, each of the focus detection areas 18a through 18c is indicated by a pair of square brackets (left and right square brackets “[ ]”) on the screen 18.

When face images, the number of which corresponds to the number of the focus detection areas, are recognized, it is possible not to recognize other face images thereafter. However, if faces images, the number of which is greater than the number of the focus detection areas, are detected and recognized based on the entire photographing image data of one captured image, it is possible to select the largest face image, the smallest face image and a medium-size face image whose area is in between the largest face image and the smallest face image and to set three focus detection areas on these three selected face images, respectively. Alternatively, it is possible to select face images from among the recognized face images in accordance with priorities established beforehand and to set focus detection areas on the face images thus selected, respectively. Such priorities can be determined by assigning a higher priority to a focus detection area the closer it is to the center of the screen 18, assigning a higher priority to a focus detection area the larger it is in size, and assigning weights to these priorities to assign priorities to focus detection areas.

Although the number of the focus detection areas is three in the second embodiment of the digital camera, the number of the focus detection areas can be two or more than three.

In addition, in the second embodiment of the digital camera, a focus search process in which the CPU 15 detects contrasts of images (face images) in the focus detection areas 18a, 18b and 18c while moving the focusing lens group L1 from one to the other of the near extremity (shortest focus position) and the far extremity (infinite focus position) is performed to detect a peak contrast value of the image in each of the focus detection areas 18a, 18b and 18c, and the positions (in-focus lens positions) of the focusing lens group L1 at which the peak contrast values are obtained are stored in memory. The focusing lens group L1 is driven from the near extremity toward the far extremity if the average size of the areas 101a and 102a of the face images 101i and 102i or the areas 103a, 104a and 105a of the face images 103i, 104i and 105i is equal to or greater than a predetermined threshold value, or the focusing lens group L1 is driven from the far extremity toward the near extremity if the average size of the areas 101a and 102a of the face images 101i and 102i or the areas 103a, 104a and 105a of the face images 103i, 104i and 105i is smaller than the predetermined threshold value. When the digital camera is not in the multi-point AF mode, the focusing lens group L1 is driven from the near extremity toward the far extremity if the current position of the focusing lens group L1 is closer to the near extremity than the far extremity, or driven from the far extremity toward the near extremity if the current position of the focusing lens group L1 is closer to the far extremity than the near extremity.

Upon a peak contrast value being detected in each of all the set focus detection areas 18a through 18c or upon the focusing lens group L1 reaching the search end extremity (the far extremity or the near extremity), the stepwise driving operation of the focusing lens group L1 is terminated to end the focus search process. Thereupon, an image capturing operation is performed on the recognized face images in a sequential order, starting from the in-focus lens position closest to the current position of the focusing lens group L1, by moving the focusing lens group L1 sequentially to the aforementioned in-focus lens positions stored in memory.

The image capturing sequence can be determined so that the image capturing operation starts from the in-focus lens position closest to the near extremity or the far extremity regardless of the position at which the focus search operation is terminated. In this case, it is desirable that this image capturing sequence be freely changed by the user.

When no face image is recognized, the CPU 15 detects peak contrast values using image signals of images in the focus detection areas 18a, 18b and 18c located at preset positions and calculates in-focus lens positions of the focusing lens group L1 via the conventional multi-point AF mode.

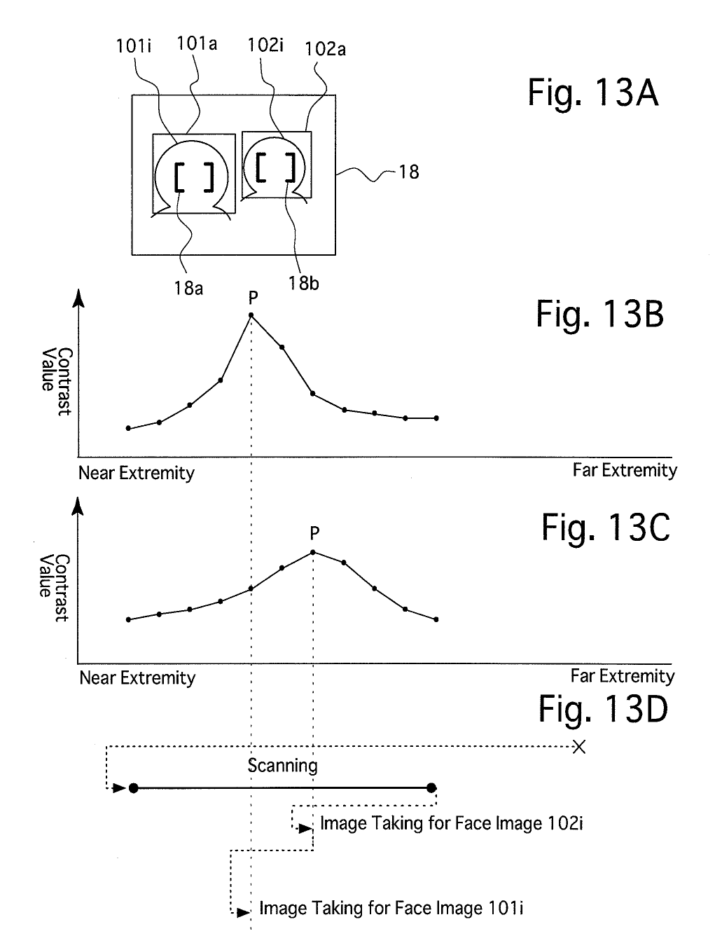

The continuous face-recognition photographing mode that includes the above described face recognition AF mode will be hereinafter discussed with reference to FIGS. 11A through 12C and FIGS. 13A through 15B. FIGS. 13A through 13D illustrate the concept of a process performed in the continuous face-recognition photographing mode in the case where persons to be photographed are positioned as shown in FIG. 11A. In the continuous face-recognition photographing mode, it is assumed that the persons 101 and 102 are detected (see FIG. 13A) and that the focus detection areas 18a and 18b are set (see FIG. 12A) correspondingly. FIG. 13B is a graph showing the relationship between contrast values in the focus detection area 18a and positions of the focusing lens group L1, FIG. 13C is a graph showing the relationship between contrast values in the focus detection area 18b and positions of the focusing lens group L1, and FIG. 13D shows a manner of movement of the focusing lens group L1.

In the focus search process in the face detection AF mode in the second embodiment of the digital camera in the case shown in FIGS. 11A and 12A where persons to be photographed are in a short distance range, the focusing lens group L1 is moved stepwise toward the far extremity after being moved to the near extremity. During this stepwise movement of the focusing lens group L1, an image capturing operation is performed each time the focusing lens group L1 is moved by one step to detect contrast values of image data in each of the focus detection area 18a and 18b at different positions of the focusing lens group L1 in the optical axis direction, respectively. Thereafter, the focus search process is terminated upon a peak contrast value being detected in each of the focus detection area 18a and 18b.

Thereafter, firstly the focusing lens group L1 is moved to one of the two in-focus lens positions which is closer to the stop position of the focusing lens group L1 at the termination of the focus search process (i.e., the in-focus lens position of the focusing lens group L1 for bringing the face image 102i into focus) and thereupon an image capturing operation is performed, and subsequently, the focusing lens group L1 is moved to the other in-focus lens position that is farther from the stop position of the focusing lens group L1 at the termination of the focus search process (i.e., the in-focus lens position of the focusing lens group L1 for bringing the face image 101i into focus) and thereupon an image capturing operation is performed. Namely, a process similar to focus bracketing is performed.

Although an image capturing operation is performed after detection of a peak contrast value in each of all the focus detection areas 18a and 18b in the above described embodiment, in an alternative embodiment, a process is performed in which the focusing lens group L1 is moved to an in-focus lens position thereof at which a peak contrast value is obtained, and thereupon an image capturing operation is performed each time a peak contrast value is detected during the focus search process is repeated on each of all the focus detection areas 18a and 18b until an image capturing operation is completed with focus being achieved on each of all the focus detection areas 18a and 18b.

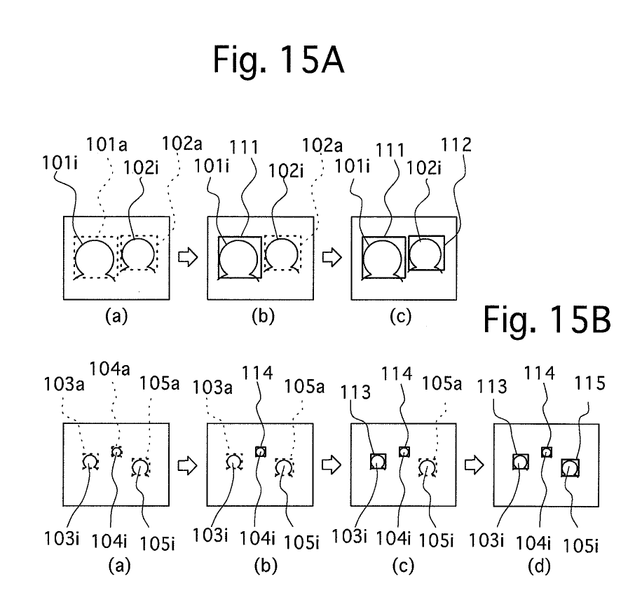

FIGS. 15A(a), 15A(b) and 15A(c) show a sequence of indications on the screen 18 when peak contrast values are detected during the focus search process in the case shown in FIGS. 11A and 12A. FIG. 15A(a) shows an indication on the screen 18 at the commencement of the focus search process performed on the face images 101i and 102i, FIG. 15A(b) shows an indication on the screen 18 upon a peak contrast value being detected in the image signal of the face image 101i, and FIG. 15A(c) shows an indication on the screen 18 upon a peak contrast value being detected in the image signal of the face image 102i. Upon peak contrast values in the image signals of the face images 101i and 102i being detected, in-focus frames 111 and 112 which surround the face images 101i and 102i are superimposed on the image displayed on the LCD monitor 17, respectively. In other words, upon a peak contrast value being detected, the in-focus frame (111 or 112) which surrounds the associated face image (101i or 102i) is superimposed on the image displayed on the LCD monitor 17. By viewing the in-focus frame 111 and 112, the user can visually recognize the face images which will be captured in an in-focus state.

Although the in-focus frames 111 and 112 are indicated to correspond to the areas 101a and 102a, the in-focus frames 111 and 112 can visually inform the user that the face images 101i and 102i are currently in focus by changing the colors of the in-focus frames 111 and 112 each time a peak contrast value is detected or by indicating the in-focus frames 111 and 112 each time a peak contrast value is detected, respectively. A boundary line of the focus detection area 18a (e.g., left and right square brackets indicating the focus detection area 18a) can be used instead of the in-focus frame 111, while a boundary line of the focus detection area 18b (e.g., left and right square brackets indicating the focus detection area 18b) can be used instead of the in-focus frame 112.

When an image capturing operation is performed upon the completion of the focus search process, the face images 101i and 102i are sequentially brought into focus and captured by the image pickup device 11 in the inverse order of detection of peak contrast values; namely, firstly the face image 102i is brought into focus and thereupon an image capturing operation is performed and subsequently the face image 101i is brought into focus and thereupon an image capturing operation is performed. In this case, each time an image capturing operation is performed, it is desirable to change the color of the associated in-focus frame (111 or 112) or to erase the in-focus frame (111 or 112) on which the image capturing operation is completed.

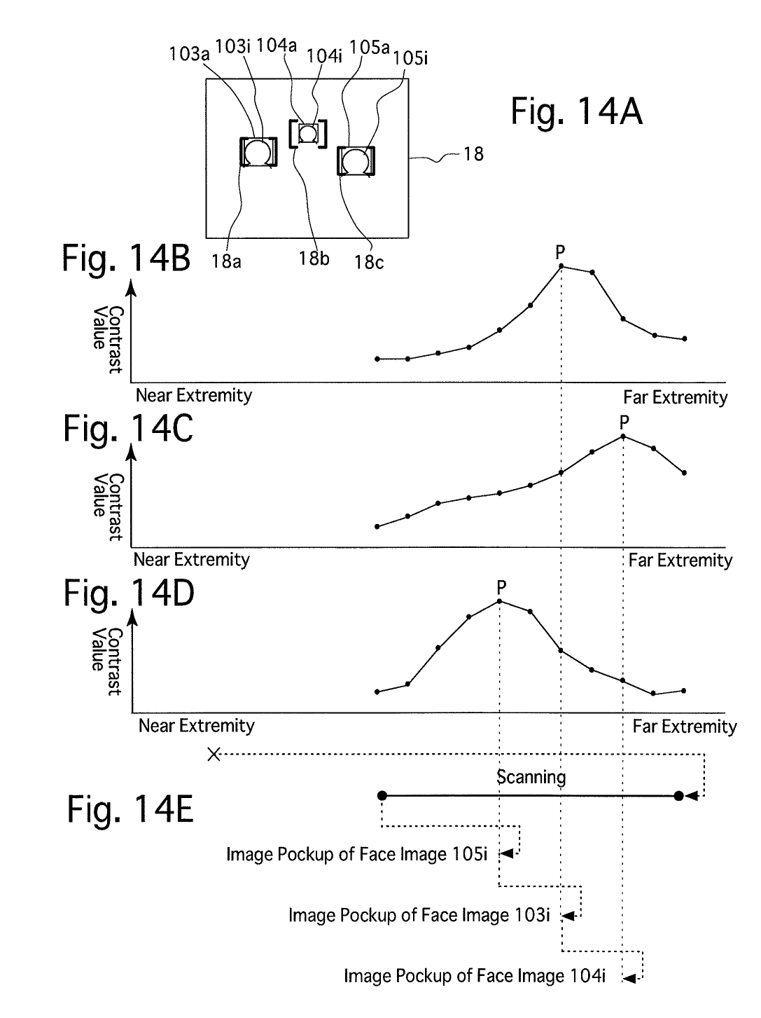

FIGS. 14A through 14D illustrate the general outlines of a process performed in the continuous face-recognition photographing mode in the case where the persons to be photographed are positioned as shown in FIG. 11B. In the continuous face-recognition photographing mode, it is assumed that the persons 103, 104 and 105 are detected (see FIG. 14A) and that the focus detection areas 18a, 18b and 18c are set (see FIG. 12B). FIG. 14B is a graph showing the relationship between contrast values in the focus detection area 18a and positions of the focusing lens group L1, FIG. 14C is a graph showing the relationship between contrast values in the focus detection area 18b and positions of the focusing lens group L1, FIG. 14D is a graph showing the relationship between contrast values in the focus detection area 18c and positions of the focusing lens group L1, and FIG. 14E shows a manner of movement of the focusing lens group L1.

In the focus search process in the face detection AF mode in the second embodiment of the digital camera in the case shown in FIG. 11B and 12B where persons to be photographed are in a far distance range, the focusing lens group L1 is moved stepwise toward the near extremity after being moved to the far extremity. During this stepwise movement of the focusing lens group L1, an image capturing operation is performed each time the focusing lens group L1 is moved by one step to detect contrast values of image data in each of the focus detection area 18a, 18b and 18c at different positions of the focusing lens group L1 in the optical axis direction, respectively. Thereafter, the focus search process is terminated upon a peak contrast value being detected in each of the focus detection area 18a, 18b and 18c.

Thereafter, firstly the focusing lens group L1 is moved to one of the three in-focus lens positions which is the closest to the stop position of the focusing lens group L1 at the termination of the focus search process (i.e., the in-focus lens position of the focusing lens group L1 for bringing the face image 105i into focus) and thereupon an image capturing operation is performed. Subsequently, the focusing lens group L1 is moved to another in-focus lens position which is the second closest to the stop position of the focusing lens group L1 at the termination of the focus search process (i.e., the in-focus lens position of the focusing lens group L1 for bringing the face image 103i into focus) and thereupon an image capturing operation is performed. Lastly, the focusing lens group L1 is moved to the other in-focus lens position which is the farthest from the stop position of the focusing lens group L1 at the termination of the focus search process (i.e., the in-focus lens position of the focusing lens group L1 for bringing the face image 104i into focus) and thereupon an image capturing operation is performed. Namely, a process similar to focus bracketing is performed.

Although an image capturing operation is performed after detection of a peak contrast value in each of all the focus detection areas 18a, 18b and 18c in the above described embodiment, in another embodiment, a process is performed in which the focusing lens group L1 is moved to an in-focus lens position thereof at which a peak contrast value is obtained and thereupon an image capturing operation is performed each time a peak contrast value is detected during the focus search process is repeated on each of all the focus detection areas 18a, 18b and 18c until an image capturing operation is completed with focus being achieved on each of all the focus detection areas 18a, 18b and 18c.

FIGS. 15B(a), 15B(b), 15B(c) and 15B(d) show a sequence of indications on the screen 18 when peak contrast values are detected during the focus search process in the case shown in FIG. 11B and 12B. FIG. 15B(a) shows an indication on the screen 18 at the commencement of the focus search process performed on the face images 103i, 104i and 105i, FIG. 15B(b) shows an indication on the screen 18 upon a peak contrast value being detected in the image signal of the face image 104i, FIG. 15B(c) shows an indication on the screen 18 upon a peak contrast value being detected in the image signal of the face image 103i, and FIG. 15B(d) shows an indication on the screen 18 upon a peak contrast value being detected in the image signal of the face image 105i. Upon peak contrast values in the image signals of the face images 103i, 104i and 105i being detected, in-focus frames 113, 114 and 115 which surround the face images 103i, 104i and 105i are superimposed on the image displayed on the LCD monitor 17, respectively. In other words, upon a peak contrast value being detected, the in-focus frame (113, 114 or 115) which surrounds the associated face image (103i, 104i or 105i) is superimposed on the image displayed on the LCD monitor 17. By viewing the in-focus frames 113, 114 and 115, the user can visually recognize the face images which will be captured in an in-focus state.

Although being indicated to correspond to the areas 103a, 104a and 105a, the in-focus frames 113, 114 and 115 can visually inform the user that the face images 103i, 104i and 105i are currently in focus by changing the colors of the in-focus frames 113, 114 and 115 each time a peak contrast value is detected or by indicating the in-focus frames 113, 114 and 115 each time a peak contrast value is detected, respectively. A boundary line of the focus detection area 18a (e.g., left and right square brackets indicating the focus detection area 18a) can be used instead of the in-focus frame 113, a boundary line of the focus detection area 18b (e.g., left and right square brackets indicating the focus detection area 18b) can be used instead of the in-focus frame 114, and a boundary line of the focus detection area 18c (e.g., left and right square brackets indicating the focus detection area 18c) can be used instead of the in-focus frame 115.

When an image capturing operation is performed upon the completion of the focus search process, the face images 103i, 104i and 105i are sequentially brought into focus and captured by the image pickup device 11 in the inverse order of detection of peak contrast values; namely, firstly the face image 105i is brought into focus and thereupon an image capturing operation is performed, subsequently the face image 103i is brought into focus and thereupon an image capturing operation is performed, and lastly the face image 104i is brought into focus and thereupon an image capturing operation is performed. In this case, each time an image capturing operation is performed, it is desirable to change the color of the associated in-focus frame (113, 114 or 115) or to stop displaying the in-focus frame (113, 114 or 115) on which the image capturing operation is completed.

As described above, according to each of the above described embodiments shown in FIGS. 11A through 15B(d), since an in-focus lens position of the focusing lens group L1 for bringing objects which are to be photographed (two persons 101 and 102, or three persons 103, 104 and 105) into focus is estimated from the average size of the areas (101a and 102a, or 103a, 104a and 105a) of the face images (101 and 102, or 103, 104 and 105), and since one of the near extremity and the far extremity of the focusing lens group L1 which is closer to the estimated in-focus lens position is determined to serve as the search start extremity of the focusing lens group L1, the time required for the focus search operation when the face recognition function is activated can be reduced. Moreover, in the continuous face-recognition photographing mode, the time required for face-image continuous photography is reduced since a focusing operation and an image capturing operation start from one of the detected in-focus lens positions of the focusing lens group L1 which is closer to the stop position of the focusing lens group L1 at the termination of the focus search process.

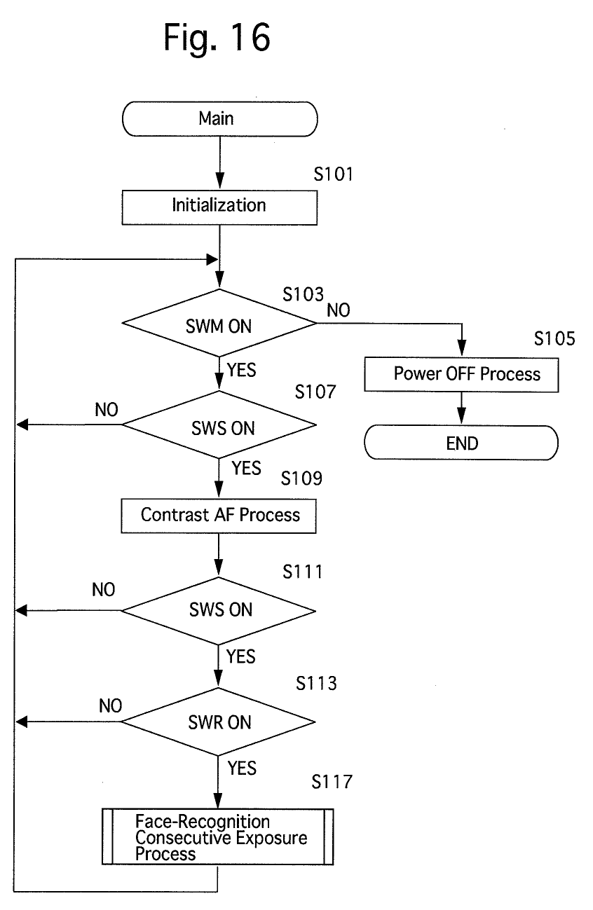

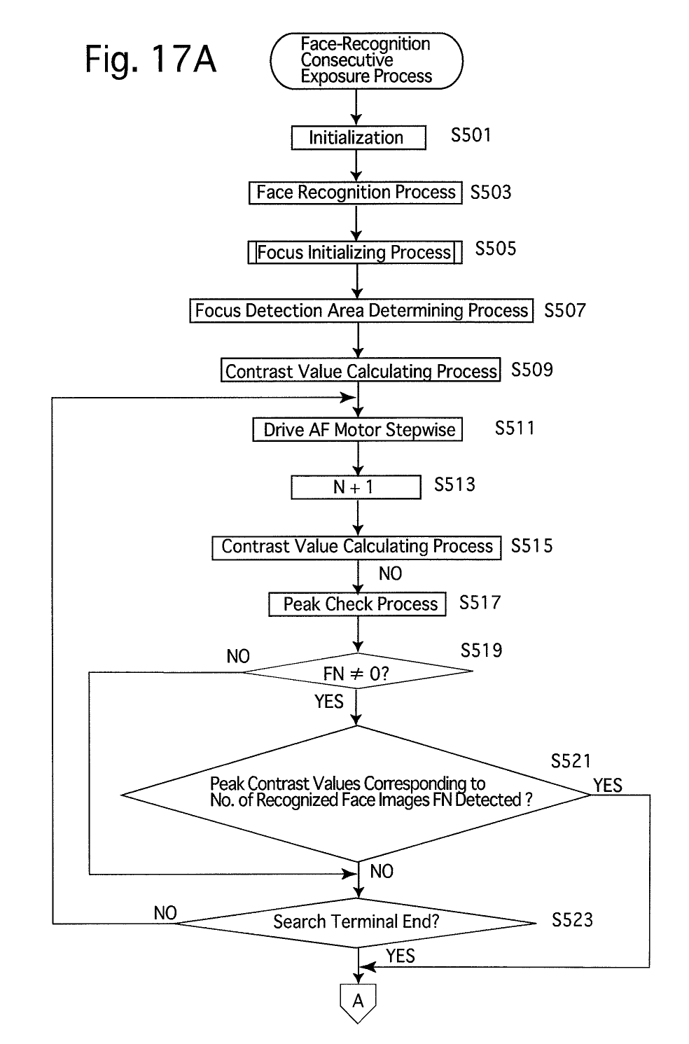

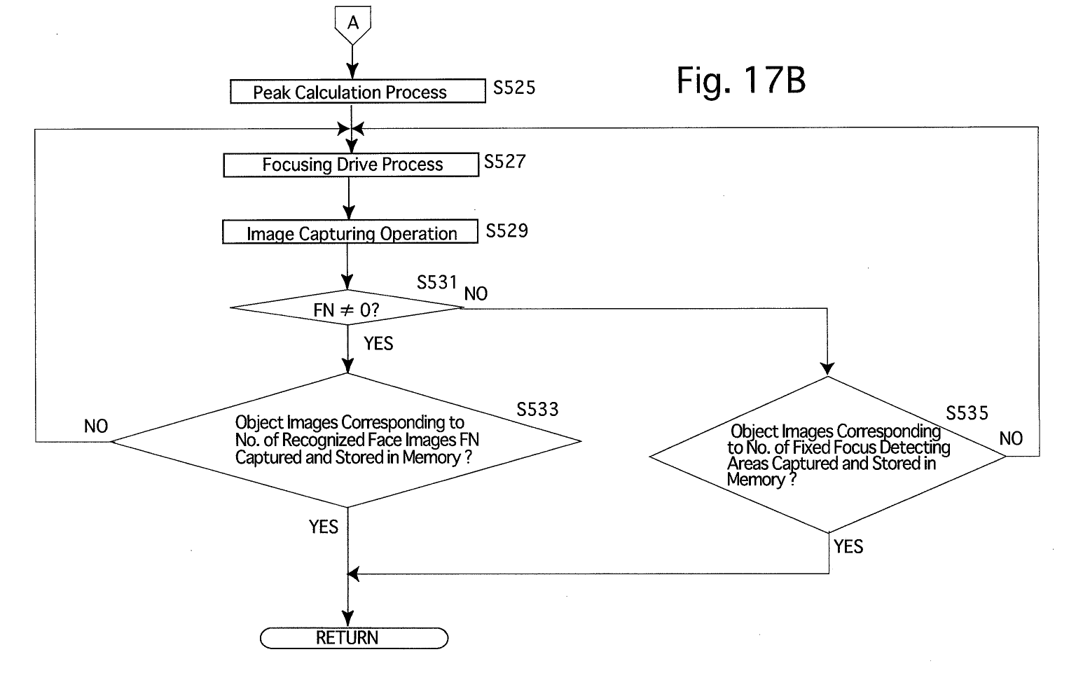

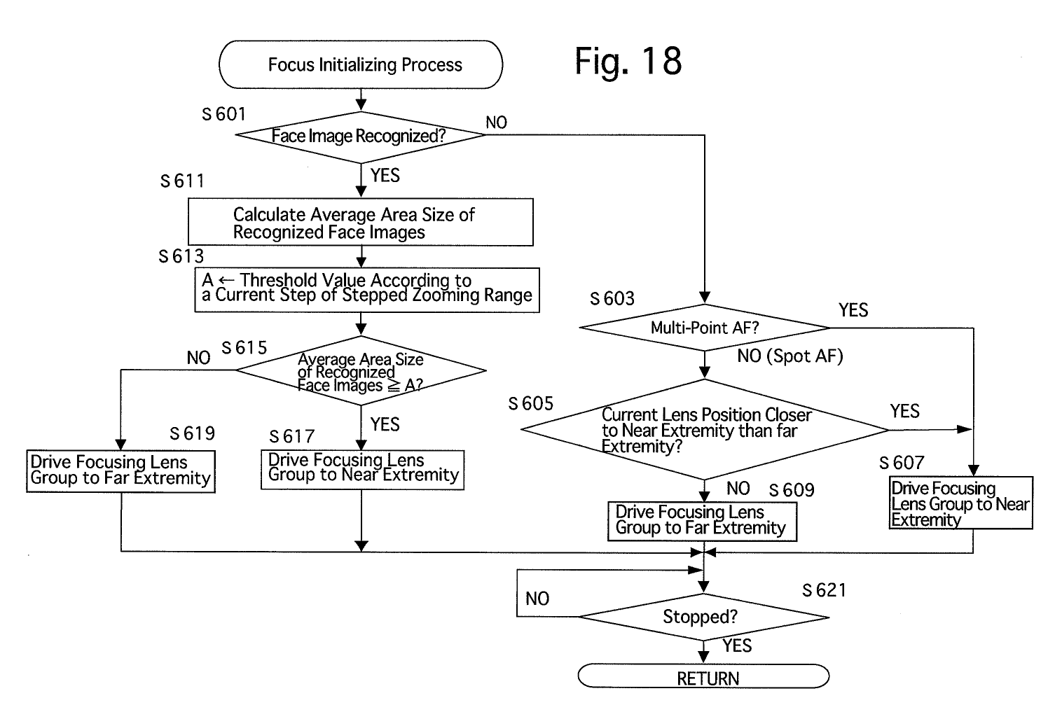

The face-recognition consecutive exposure process performed in the second embodiment of the digital camera will be hereinafter discussed in detail with reference to the flowcharts shown in FIGS. 16 and 17. FIG. 16 is a flow chart showing a main process (sequence of operations) performed in the second embodiment of the digital camera. This main process is identical to that shown in FIG. 7 that is performed in the first embodiment of the digital camera except that the flow chart shown in FIG. 16 includes face-recognition consecutive exposure processes at steps S109 and S117 instead of the contrast AF process step S109 and the image capturing operation at step S115 shown in FIG. 7, and accordingly, a detailed description of the main process shown in FIG. 16 is omitted.

Note that in the contrast AF process performed at step S109, the focusing lens group L1 is moved stepwise from the near extremity to the far extremity in accordance with the focus search operation while peak contrast values are detected for each focus detection area 18a, 18b and 18c which has detected face images 103i, 104i and 105i, respectively; the in-focus positions of the focusing lens group L1 are calculated; and the focusing lens group L1 is moved to the in-focus position which is closest to the near extremity. In the second embodiment, in the case where the photometering switch SWS has been continuously ON, the AF search process is not performed even if control enters the contrast AF process upon the focusing lens group L1 moving to the in-focus position, i.e., a “one-shot AF” is performed.

The face-recognition consecutive exposure process that is performed at step S117 will be hereinafter discussed in detail with reference further to the flow charts shown in FIGS. 17A and 17B.

In the face-recognition consecutive exposure process, firstly various variables are initialized (step S501). For instance, in the second embodiment of the digital camera, a variable for setting the number of recognized face images is initialized, and the number of recognized face images FN is initialized.

Subsequently, the face recognition process is carried out to recognize one or more face images using a read-in image signal (step S503). A known face recognition method is adopted as the face recognition process performed at step S503. Upon a face image being recognized by this face recognition process, a focus detection area is set to correspond to the area of the recognized face image, and the number of recognized face images FN is incremented by one. In this embodiment, the maximum number of recognized face images FN is 3.

Subsequently, a focus initializing process (see FIG. 18) is performed (step S505). In this focus initializing process, the focusing lens group L1 is moved to either the near extremity or the far extremity in accordance with the result of face recognition and the determinations whether or not certain conditions are satisfied, e.g., the determination whether or not a face image has been recognized and the determination whether or not the currently-set AF mode is a multi-point AF mode. Thereupon, if a face image is recognized, the direction to move the focusing lens group L1 in the focus search operation is set to the direction from the near extremity toward the far extremity if the area size of the recognized face image is equal to or greater than a predetermined threshold value, or set to the direction from the far extremity toward the near extremity if the area size of the recognized face image is not equal to or greater than the predetermined threshold value. If no face image is recognized, the focusing lens group L1 is moved from the near extremity toward the far extremity if the currently-set AF mode is the multi-point AF mode. If no face image is recognized and if the currently-set AF mode is not the multi-point AF mode, the focusing lens group L1 is moved from one of the near extremity and the far extremity which is closer to the current position of the focusing lens group toward to the other.

It is desirable that the aforementioned threshold value be changed according to the focal length of the zoom lens L. For instance, the threshold value is changed to be greater and smaller as the focal length becomes longer and shorter, respectively.

Subsequently, the focus detection areas 18a through 18c which are to be used for the focus search operation (scanning operation) are selected and set (step S507). If at least one face image is recognized in the face recognition process at step S503, information on the position of the recognized face image is obtained and each focus detection area 18a through 18c is set to be centered with respect to the associated recognized face image. If no face image is recognized in the face recognition process at step S503, all the three fixed focus detection areas 18a, 18b and 18c are selected.

Thereafter, an image capturing operation is performed to capture an image signal of an image in each focus detection area set at step S507 at the search start extremity of the focusing lens group L1, and a contrast value calculating process is performed (step S509). Namely, based on the image data in the focus detection areas 18a through 18c that is input from the image pickup device 11, the contrast value P[0] at the initial position of the focusing lens group L1 is calculated, and the maximum contrast value Max and the minimum contrast value Min are updated.

Subsequently, the AF motor 25 is driven by one step in the direction to move the focusing lens group L1 toward the search end extremity (step S511), and the lens-position pulse number N is incremented by one in accordance with the direction of movement of the focusing lens group L1 (step S513). Thereafter, a contrast value calculating process is performed (step S515). In this contrast value calculating process, a contrast value P[N] is calculated in accordance with image data captured by the image pickup device 11, and the maximum contrast value and the minimum contrast value are updated. Subsequently, a peak check process is performed which determines whether or not the contrast value P[N] calculated at step S515 is a peak contrast value which satisfies preset conditions (step S517). Although the peak check process can use a known algorithm, it is determined whether or not the central contrast value among a group of nine contrast values respectively calculated at immediate consecutive nine positions of the focusing lens group L1 at each focus detection area 18a through 18c set at step S507 is a peak contrast value.

Subsequently, it is determined whether or not the number of recognized face images FN is not 0 (step S519). If the number of recognized face images FN is not 0 (if YES at step S519), it is determined whether or not peak contrast values, the number of which corresponds to the number of recognized face images FN, have been detected (step S521). If peak contrast values, the number of which corresponds to the number of recognized face images FN, have not yet been detected (if NO at step S521), it is determined whether or not the focusing lens group L1 has reached the search end extremity (step S523). If the focusing lens group L1 has not reached the search end extremity (if NO at step S523), control returns to step S511 so that the above described operations at steps S511 through S523 are repeated. If the number of recognized face images FN is 0 (if NO at step S519), it is determined whether or not the focusing lens group L1 has reached the search end extremity (step S523). If the focusing lens group L1 has not reached the search end extremity (if NO at step S523), control returns to step S511 so that the above described operations at steps S511 through S523 are repeated. Namely, when one or more face images are recognized, the focus search process is terminated upon a peak contrast value being detected on each of all the set associated focus detection areas 18a through 18c; on the other hand, when no face image is recognized, the focus search process continues to be performed until the focusing lens group L1 reaches the search end extremity.

If peak contrast values, the number of which corresponds to the number of recognized face images FN, have been detected (if YES at step S521) or if the focusing lens group L1 has reached the search end extremity (if YES at step S523), a peak calculation process for calculating a peak contrast value (by linear approximation) is performed in accordance with the nine contrast values at consecutive nine lens positions (one of which a peak contrast value has been obtained) which are obtained in the loop process at steps S511 through S523 (step S525). Namely, an estimated more precise peak contrast value and the position of the focusing lens group L1 at which this estimated more precise peak contrast value is obtained are calculated by linear approximation because there is a possibility of a real peak contrast value existing in the vicinity of a peak contrast value among the contrast values respectively calculated at the stepwise stop positions of the focusing lens group L1.

A focusing drive process is performed in which the focusing lens group L1 is moved to the lens position thereof thus obtained (step S527). In this embodiment, if the number of recognized face images FN is equal to or greater than 2, or if in-focus lens positions of the focusing lens group L1 are obtained from a plurality of focus detection areas even if the number of recognized face images FN is 0, the focusing lens group L1 is moved sequentially to the obtained in-focus lens positions each time control enters step S527, starting from the in-focus lens position closest to the current position of the focusing lens group L1.

Upon the focusing lens group L1 being moved to an in-focus lens position of the focusing lens group L1, an image capturing operation is performed using the image pickup device 11 to capture an in-focus object image and data on the in-focus object image thus captured is stored in the image memory 21 (step S529).

Subsequently, it is determined whether or not the number of recognized face images FN is not 0 (step S531). If the number of recognized face images FN is not 0 (if YES at step S531), it is determined whether or not object images, the number of which corresponds to the number of recognized face images FN, have been captured and stored in the image memory 21 (step S533). If object images, the number of which corresponds to the number of recognized face images FN, have not yet been captured or stored in the image memory 21 (if NO at step S533), control returns to step S527 to repeat the operations at steps 527 and 529, in which the focusing lens group L1 is moved to the subsequently in-focus lens position thereof, an object image is captured and image data on this captured object image is stored in the image memory 21. If object images, the number of which corresponds to the number of recognized face images FN. have been captured and stored in the image memory 21 (if YES at step S533), control returns.

If the number of recognized face images FN is 0 (if NO at step S531), it is determined whether or not object images, the number of which corresponds to the number of the fixed focus detection areas, have been captured and stored in the image memory 21 (step S535). If object images, the number of which corresponds to the number of the fixed focus detection areas, have not yet been captured or stored in the image memory 21 (if NO at step S535), control returns to step S527 to repeat the operations at steps 527 and 529, in which the focusing lens group L1 is moved to the subsequently in-focus lens position thereof, an object image is captured and image data on this captured object image is stored in the image memory 21. If object images, the number of which corresponds to the number of the fixed focus detection areas, have captured and stored in the image memory 21 (if YES at step S535), control returns.

FIG. 18 shows the focus initializing process performed at step S505 in the face-recognition consecutive exposure process shown in FIGS. 17A and 17B.

In the focus initializing process shown in FIG. 18, firstly it is determined whether or not a face image has been recognized at the face recognition process at step S503 (step S601). If no face image has been recognized (if NO at step S601), it is determined whether or not the currently-set AF mode is the multi-point AF mode (step S603). If the currently-set AF mode is the multi-point AF mode (if YES at step S603), the AF motor 25 is driven to move the focusing lens group L1 to the near extremity (step S607). If the currently-set AF mode is not the multi-point AF mode, i.e., if the currently-set AF mode is the spot AF mode (if NO at step S603), it is determined whether or not the focusing lens group L1 is closer to the near extremity than the far extremity (step S605). If the focusing lens group L1 is closer to the near extremity than the far extremity (if YES at step S605), the AF motor 25 is driven to move the focusing lens group L1 to the near extremity (step S607). If the focusing lens group L1 is not closer to the near extremity than the far extremity (if NO at step S605), the AF motor 25 is driven to move the focusing lens group L1 to the far extremity (step S609). Thereafter, control waits for the focusing lens group L1 to reach the search end extremity (the near extremity or the far extremity) to thereby stop the AF motor 25 (if NO at step S621). Immediately after the AF motor 25 stops rotating (if YES at step S621), control returns.

On the other hand, if a face image has been recognized at the face recognition process at step S503 (if YES at step S601), the average size of the areas 101a and 102a of the face images 101i and 102i or the areas 103a, 104a and 105a of the face images 103i, 104i and 105i is calculated (step S611). Subsequently, a threshold value according to the current step of the stepped zooming range is set to a threshold value A (step S613), and subsequently, it is determined whether or not the average area size calculated at step S611 is equal to or greater than the threshold value A (step S615). If the average area size calculated at step S611 is equal to or greater than the threshold value A (if YES at step S615), the AF motor 25 is driven to move the focusing lens group L1 to the near extremity (step S617). If the average area size calculated at step S611 is not equal to or greater than the threshold value A (if NO at step S615), the AF motor 25 is driven to move the focusing lens group L1 to the far extremity (step S619). Thereafter, control waits for the focusing lens group L1 to reach the search end extremity (the near extremity or the far extremity) to thereby stop the AF motor 25 (if NO at step S621). Immediately after the AF motor 25 stops rotating (if YES at step S621), control returns.

In the second embodiment of the digital camera, by the focus initialing process shown in FIG. 18, the near extremity of the focusing lens group L1 becomes the search start extremity if the average size of the areas (101a and 102a, or 103a, 104a and 105a) is equal to or greater than the predetermined threshold value A (see FIGS. 13A through 13D), and the far extremity of the focusing lens group L1 becomes the search start extremity if the average size of the areas (101a and 102a, or 103a, 104a and 105a) is not equal to or greater than the predetermined threshold value A (see FIGS. 14A through 14E).

In the focus initializing process shown in FIG. 18, the near extremity and the far extremity of the focusing lens group L1 serve as the search start extremity and the search end extremity, respectively, if the focusing lens group L1 is moved to the near extremity at steps S607 and S617. Conversely, the far extremity and the near extremity of the focusing lens group L1 serve as the search start extremity and the search end extremity, respectively, if the focusing lens group L1 is moved to the far extremity at steps S609 and S619.

The focus detection area determining process performed at step S507 is identical to the focus detection area determining process shown in FIG. 10, and accordingly, the detailed description of the focus detection area determining process performed at step S507 is omitted.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A camera having a focus adjusting system and a face recognition function, comprising:
an image pickup device for capturing an object image formed via a photographing optical system including a focusing lens group movable along an optical axis;
a focus adjusting device which performs a focus search process, wherein said image pickup device is activated to capture an object image at each of a plurality of different positions of said focusing lens group in said optical axis direction while said focusing lens group is moved along said optical axis to detect an in-focus lens position of said focusing lens group in said optical axis direction, based on image signals of said object images obtained at said plurality of different positions of said focusing lens group, and wherein said focusing lens group is moved to said in-focus lens position detected by said focus search process; and
a face recognition device for recognizing a face image based on said image signals,
wherein, when said face recognition device recognizes said face image, said focus adjusting device performs said focus search process so that said focusing lens group moves toward a near extremity in the case where the area size of said face image is smaller than a predetermined threshold value, and so that said focusing lens group moves toward a far extremity in the case where said area size of said face image is one of equal to and greater than said predetermined threshold value.

2. The camera having a focus adjusting system and a face recognition function according to claim 1, wherein, when said face recognition device recognizes said face image, said focus adjusting device detects said in-focus lens position of said focusing lens group as a position at which an in-focus state is achieved on said face image recognized by said face recognition device.

3. The camera having a focus adjusting system and a face recognition function according to claim 1, wherein, when said face recognition device recognizes said face image, said focus adjusting device sets an image area which includes said face image to serve as a focus detection area, and detects said in-focus lens position of said focusing lens group based on an image signal of said face image formed in said focus detection area.

4. The camera having a focus adjusting system and a face recognition function according to claim 3, wherein the size of said focus detection area remains unchanged regardless of the size of said image area.

5. The camera having a focus adjusting system and a face recognition function according to claim 3, wherein said focus adjusting device detects said in-focus lens position of said focusing lens group as a position thereof in said optical axis direction at which a peak contrast value in said image signal of said face image formed in said focus detection area is obtained.

6. The camera having a focus adjusting system and a face recognition function according to claim 5, wherein, upon said peak contrast value being obtained during said focus search process, said focus adjusting device terminates said focus search process and moves said focusing lens group to said position at which said peak contrast value is obtained.

7. The camera having a focus adjusting system and a face recognition function according to claim 1, wherein said photographing optical system comprises a zoom lens, and
wherein said predetermined threshold value is determined based on a currently-set focal length of said zoom lens.

8. The camera having a contrast-detection focus adjusting system according to claim 1, further comprising a monitor which displays said object image captured by said image pickup device,
wherein, when said face recognition device recognizes said face image while said focus adjusting device performs said focus search process, an image signal of an object image which is formed in an image area including said face image is extracted from among said image signals of said object images captured at said plurality of different positions of said focusing lens group to indicate a zoom-in image of said face image on said monitor.

9. The camera having a focus adjusting system a face recognition function according to claim 8, wherein said object image captured by said image pickup device is displayed on said monitor after said focusing lens group is moved to said in-focus lens position following termination of said focus search process.

10. The camera having a focus adjusting system a face recognition function according to claim 8, wherein, upon focus being achieved on said image area including said face image, an identification indication which visually identifies said image area including said face image is indicated on said monitor.

11. The camera having a focus adjusting system and a face recognition function according to claim 10, wherein said identification indication comprises a highlighted frame which surrounds said face image.

12. The camera having a contrast-detection focus adjusting system according to claim 1, further comprising a monitor which displays said object image captured by said image pickup device,
wherein, when said face recognition device recognizes said face image while said focus adjusting device performs said focus search process, the manner of indication of said monitor is switched to a zoom-in indication manner in which an image of the image signal obtained from an area of said recognized face image is zoomed in to be indicated on said monitor as a zoom-in image, while said focus adjusting device performs said focus search process.

13. The camera having a focus adjusting system a face recognition function according to claim 12, wherein the manner of indication of said monitor is switched back to the aforementioned normal manner upon completion of the focusing drive process, when said focus search process is terminated.

14. A camera having a focus adjusting system and a face recognition function, comprising:
an image pickup device for capturing an object image formed via a photographing optical system including a focusing lens group movable along an optical axis;
a focus adjusting device which performs a focus search process, wherein said image pickup device is activated to capture an object image at each of a plurality of different positions of said focusing lens group in said optical axis direction while said focusing lens group is moved along said optical axis between a near extremity thereof and a far extremity thereof to detect an in-focus lens position of said focusing lens group in said optical axis direction, based on image signals of said object images obtained at said plurality of different positions of said focusing lens group, and wherein said focusing lens group is moved to said in-focus lens position detected by said focus search process; and
a face recognition device for recognizing a face image based on said image signals,
wherein, when said face recognition device recognizes said face image, said focus adjusting device performs said focus search process so that said focusing lens group moves from said far extremity toward said near extremity in the case where the area size of said face image is smaller than a predetermined threshold value, and so that said focusing lens group moves from said near extremity toward said far extremity in the case where said area size of said face image is one of equal to and greater than said predetermined threshold value.

15. A camera having a focus adjusting system and face recognition function, comprising:
an image pickup device for capturing an object image formed via a photographing optical system including a focusing lens group which is movable along an optical axis;
a face recognition device for recognizing face images based on said image signals;
a focus adjusting device which performs a focus search process, wherein said image pickup device is activated to capture said object image at each of a plurality of different positions of said focusing lens group in said optical axis direction while said focusing lens group is moved along said optical axis to detect a focus state based on image signals of said object images obtained at said plurality of different positions of said focusing lens group; and
a controller which determines an average value of areas of said face images recognized by said face recognition device, and controls said focus adjusting device so as to perform said focus search process so that said focusing lens group moves from a near extremity thereof toward a far extremity thereof in the case where said average value is one of equal to and greater than a predetermined value and so that said focusing lens group moves from said far extremity toward said near extremity if said average value is smaller than said predetermined value, when said face recognition device recognizes said face images.

16. The camera having a focus adjusting system and face recognition function according to claim 15, wherein, when said face recognition device recognizes said face images, said controller controls said focus adjusting device so as to detect a focus state on each of said areas of said face images recognized by said face recognition device to determine in-focus lens positions of said focusing lens group at which an in-focus state is achieved on said face images recognized by said face recognition device, respectively, and controls said image pickup device to as to perform an image capturing operation at each of said in-focus lens positions by moving said focusing lens group sequentially to said in-focus lens positions.

17. The camera having a focus adjusting system and face recognition function according to claim 16, wherein said controller controls said image pickup device so as to perform said image capturing operation on said recognized face images in a sequential order, starting from an in-focus lens position among said in-focus lens positions which is the closest to a stop position of the focusing lens group at a termination of said focus search process, and controls said image pickup device so as to perform said image capturing operation at each of said in-focus lens positions by moving said focusing lens group sequentially to said in-focus lens positions.

18. The camera having a focus adjusting system and face recognition function according to claim 16, wherein said predetermined value is determined in accordance with a focal length of said photographing optical system to become greater as said focal length of said photographing optical system becomes longer.

19. The camera having a focus adjusting system and face recognition function according to claim 15, wherein, when said face recognition device recognizes no face image, said focus detecting device performs said focus search process based on an image signal of a face image formed in a predetermined focus detection area.

20. The camera having a focus adjusting system and face recognition function according to claim 15, further comprising a monitor which displays said object image captured by said image pickup device,
wherein said controller sets focus detection areas to correspond to said face images recognized by said face recognition device, respectively, and
wherein said monitor displays square brackets which visually indicate said focus detection areas, said square brackets being superimposed on said face images, respectively.

21. The camera having a focus adjusting system and face recognition function according to claim 20, wherein, when said image pickup device performs said image capturing operation at each of said in-focus lens positions while said focus detecting device moves said focusing lens group sequentially to said in-focus lens positions, said controller makes said monitor indicate in-focus frames which visually identify face images on which an in-focus state is achieved, respectively, every time said image pickup device performs said image capturing operation.

22. The camera having a contrast-detection focus adjusting system according to claim 15, further comprising a monitor which displays said object image captured by said image pickup device,
wherein, when said face recognition device recognizes said face image while said focus adjusting device performs said focus search process, the manner of indication of said monitor is switched to a zoom-in indication manner in which an image of the image signal obtained from an area of said recognized face image is zoomed in to be indicated on said monitor as a zoom-in image, while said focus adjusting device performs said focus search process.

23. The camera having a focus adjusting system a face recognition function according to claim 22, wherein the manner of indication of said monitor is switched back to the aforementioned normal manner upon completion of the focusing drive process, when said focus search process is terminated.
